(19) United States
(12) Patent Application Publication
(10) Pub. No.: US 2013/0210977 A1
(43) Pub. Date: Aug. 15, 2013

(54) DESENSITIZED AQUEOUS THERMOPLASTIC POLYMER DISPERSIONS

(71) Applicants: Yunfei Yan, Shanghai (CN); Wei Chao Gu, Shanghai (CN); Dong Wang, Shanghai (CN); Wenyu Shang, Shanghai (CN); Gary M. Strandburg, Mount Pleasant, MI (US)

(72) Inventors: Yunfei Yan, Shanghai (CN); Wei Chao Gu, Shanghai (CN); Dong Wang, Shanghai (CN); Wenyu Shang, Shanghai (CN); Gary M. Strandburg, Mount Pleasant, MI (US)

(73) Assignees: ROHM AND HAAS COMPANY, Philadelphia, PA (US); DOW GLOBAL TECHNOLOGIES LLC, Midland, MI (US)

(21) Appl. No.: 13/820,885

(22) PCT Filed: Sep. 29, 2010
(86) PCT No.: PCT/CN10/77477

§ 371 Date: Apr. 26, 2013

(51) Int. Cl. C08K 5/17

(52) U.S. Cl. CPC C08K 5/175
USPC 524/157; 524/300; 524/232; 524/238; 524/522

(57) ABSTRACT

The invention generally relates to an aqueous thermoplastic polymer dispersion containing ingredients that include, among other things, a dispersion desensitizer; methods of use thereof, and articles manufactured therefrom.

### BACKGROUND OF THE INVENTION

1. Field of the Invention

The invention generally relates to an aqueous thermoplastic polymer dispersion, methods of use thereof, and manufactured articles and formulated products prepared therefrom.

2. Background Art

Thermoplastic polymers such as polyolefins are widely used in industry to prepare a variety of different manufactured products. A useful type of preparation of thermoplastic polymers such as polyolefins that can be used in the manufacture of many products is an aqueous thermoplastic polymer (e.g., polyolefin) dispersion. Aqueous thermoplastic polymer dispersions use water as a dispersion medium to disperse a finely-divided solid form of the thermoplastic polymer.

Naturally, the hydrophobic nature of many thermoplastic polymers, including polyolefins, makes forming and stabilizing aqueous thermoplastic polymer dispersions unpredictable. Dispersing agents are frequently tried in forming the dispersions, stabilizing them, or both. Examples of some types of dispersing agents are surfactants and certain polar-group containing synthetic polymers.

United States Patent Application Publication number U.S. 2007/0292705 A1 mentions, among other things, aqueous dispersions including (A) at least one ethylene-based polyolefin forming a dispersed polymer phase; (B) at least one dispersing agent; and (C) water, wherein the dispersion has a pH of less than 12; and wherein the dispersed polymer phase has a volume average particle size of less than about 5 microns. The publication also mentions water containing high levels of alkaline earth ions, such as Ca²⁺, should be avoided.

U.S. 2010/0143652 A1 mentions, among other things, a composite structure and a method of applying a froth to a substrate. The froth comprises water and a thermoplastic polymer such as, for example, a polyolefin. Some method embodiments use a foamed aqueous dispersion of the polyolefin that contains a dispersing agent and a frothing surfactant. The frothing surfactant allows a gas, commonly air, used for frothing to disperse homogeneously and efficiently into the foamed dispersion.

There is a need in the art for new aqueous thermoplastic polymer dispersions.

### BRIEF SUMMARY OF THE INVENTION

The inventors desired to make formulated products having a pH of less than pH 9, allowing extra metal cations such as Ca²⁺, or both. For example, for shampoo formulations a desirable pH is pH 5; for leather applications a desirable pH is from pH 2 to about pH 8; and for adhesive applications containing ingredients having carboxyl-containing functional groups (e.g., polyacrylic acids), a desirable pH is pH 5. The inventors determined that a valuable ingredient for these formulated products would be aqueous polyolefin dispersions comprising at least one polyolefin in a finely-divided solid form, water as a dispersion medium, and at least one hydrophobic chain-containing carboxylate salt as a dispersing agent.

The inventors surprisingly discovered, however, a problem when they tried to prepare the dispersions. When the inventors lowered pH of these dispersions (e.g., by adding measured amounts of hydrochloric acid to an initial dispersion at about pH 10), the dispersions quickly became unstable at between pH 8.9 and pH 8.5 (e.g., pH 8.6), and rapidly formed phase-separated mixtures having a mostly liquid phase and a phase containing mostly agglomerates of the finely-divided solid polyolefin. The agglomerates had significantly higher viscosity than did the dispersions and were unsuitable for use as ingredients in the intended formulated products.

Also, the inventors sought to solve the aforementioned problem (see U.S. 2007/0292705 A1) of the dispersion-destabilizing effect of a dispersion that may contain extra metal cations (e.g., from so-called hard water). The inventors found that extra metal cations caused agglomerates to form in the aqueous polyolefin dispersions, even when pH of the dispersions was greater than pH 9.

Despite unpredictability of the aqueous polyolefin dispersion art, the inventors discovered solutions to the aforementioned problems. The inventors discovered a type of dispersion desensitizer and determined agglomeration-inhibiting effective amounts thereof that would impart tolerance to pH below pH 9.0, extra metal cation content, or, preferably both to the aqueous polyolefin dispersion so as to form insensitive aqueous polyolefin dispersions. The inventors identified examples of such dispersion desensitizers, and then discovered a method for using them to prepare examples of insensitive aqueous polyolefin dispersions (insensitive dispersions).

The discovered dispersion desensitizers work surprisingly well. For example, experiments herein show that the insensitive dispersions do not agglomerate even when their pH is lowered to pH 5 and, at least in some instances, to pH 1.4 or 0.7. Also, in experiments where the insensitive dispersions contain extra metal cations, agglomerates do not form. Thus, the insensitive dispersions are useful as ingredients in the formulated products having a pH of less than pH 9.0, containing extra metal cations, or, in some embodiments, both. The inventors discovered that their solution also works with an aqueous dispersion of any agglomeration-prone thermoplastic polymer that would otherwise agglomerate when exposed to a would-be agglomeration condition such as the aforementioned pH<pH 9 or extra metal cation content condition. The inventors also discovered that their solution works with any salt of the hydrophobic chain-containing carboxylate and with or without using a polar group-containing polymer as an additional dispersion forming agent in the insensitive dispersions.

In a first embodiment, the present invention provides an insensitive aqueous agglomeration-prone thermoplastic polymer dispersion (invention dispersion) comprising a mixture comprising ingredients (a) to (d): (a) water, as a dispersion medium; (b) agglomeration-prone thermoplastic polymer (APTP) particles, which have a maximum particle size volume mean of 5 microns according to PROCEDURE PSM (described later) and are widely dispersed in the water; (c) a dispersion-forming effective amount of a dispersing carboxylate salt; and (d) an agglomeration-inhibiting effective amount of a dispersion desensitizer; wherein the dispersing carboxylate salt is a cation salt of the anion, R—CO₂⁻, a multi-cation salt of a carboxylic acid polymer comprising carboxyl-containing monomer residuals, or a combination thereof; wherein when the dispersing carboxylate salt is the multi-cation salt of the carboxylic acid polymer, the invention dispersion contains at least 1 weight percent of the carboxyl-containing monomer residuals based on ratio of weight of the carboxyl-containing monomer residuals to combined weight of ingredient (b) plus weight of the multi-cation salt of the carboxylic acid polymer; wherein R is an aliphatic radical that is unsubstituted or substituted with from 1 to 6 substituents selected from the group consisting of: —OH, —CO₂H, or a —CO₂⁻ cation salt; wherein each cation (including cations of the multi-cation salt) independently is a cation of a metal of Group 1 or 2 of the Periodic Table of the Elements, ammonium (—NH₄⁺), or a mono-, di-, tri-, or tetra-(C₁-C₆₀)alkyl substituted ammonium; and wherein the APTP particles are exposed to a would-be agglomeration condition and the dispersion desensitizer functions in such a way so as to inhibit agglomeration of the APTP particles in the insensitive aqueous agglomeration-prone thermoplastic polymer dispersion.

In a second embodiment the present invention provides a method of preparing the invention dispersion of the first embodiment, the method (invention method) comprising contacting the agglomeration-inhibiting effective amount of a dispersion desensitizer to an aqueous agglomeration-prone thermoplastic polymer predispersion comprising ingredients (a) to (c): (a) water, as a dispersion medium; (b) APTP particles, which have a maximum particle size volume mean of 5 microns according to PROCEDURE PSM (described later) and are widely dispersed in the water; and (c) a dispersion-forming effective amount of a dispersing carboxylate salt, wherein the contacting comprises mixing and, if necessary, creating a would-be agglomeration condition so that the contacting is done in such a way so as to prepare the invention dispersion of the first embodiment; and wherein the APTP particles are exposed to a would-be agglomeration condition in the dispersion and the dispersion desensitizer functions in such a way so as to inhibit agglomeration of the APTP particles in the dispersion.

In a third embodiment the present invention provides a formulated product (invention formulated product) comprising a formulation mixture comprising, or prepared from, the invention dispersion of the first embodiment and at least one additional formulation ingredient. In some embodiments the invention formulated product is a shampoo, hair conditioner, personal care product to be applied to the skin (e.g., skin conditioner, sunscreen or suntan product, and cosmetic), leather plasticizer formulation, or adhesive material.

In a fourth embodiment the present invention provides a manufactured product (invention manufactured product) comprising, or prepared from, the invention dispersion of the first embodiment. In some embodiments the manufactured product is an article of footwear, coated textile, coated paper, coating, container, film, packaging, sheet, synthetic lubricant, or tubing. In some embodiments the manufactured product is the article of footwear, coated textile, coated paper, or packaging. In some embodiments, the manufactured product has been prepared by a process comprising agglomerating (e.g., melting together) the APTP particles so as to give an agglomerated manufactured product.

In any one of the first to fourth embodiments, preferably the agglomeration-prone thermoplastic polymer is a polyolefin and the APTP particles are polyolefin particles.

As used herein, the term “additional formulation ingredient” means a substance or molecule that is not any one of ingredients (a) to (d) and functions with the invention dispersion in such a way so as to comprise or prepare the invention formulated product. The substance or molecule can be an added material other than ingredients (a) to (d) or a reaction product prepared in situ, including a reaction product prepared in situ from at least one of ingredients (a) to (d). Preferably, the substance or molecule is the added material.

The phrase “agglomeration-inhibiting effective amount” means a quantity sufficient to enable the inhibition (e.g., suppression, delayed onset, or prevention) of gathering the APTP particles into a mass. Agglomeration of the APTP particles is inhibited if a dispersion consisting of (i.e., containing only) ingredients (a) to (d) and having pH 8.0 has viscosity of less than 2,000 centipoise (cP). The invention dispersion can have a viscosity greater than 2,000 cP if it further contains an additive that increases viscosity such as, for example, a thickener. Thus in some embodiments the mixture of ingredients (a) to (d) is characterized by a viscosity of less than 2,000 centipoise measured according to PROCEDURE VM, and the invention dispersion consists of, or is prepared from, such mixture. In some circumstances it can be desirable to characterize the invention dispersion by comparing change in viscosity as a function of change in pH of the invention dispersion. Such a comparison, for example, could be obtained by measuring viscosity of at least two samples of the invention dispersion, wherein one sample has a pH 8.0 and at least one sample has a pH of from pH 7.5 to pH 1.0, and recording the pH and viscosity measurement data. Typically, all other factors being equal, the viscosity is expected to increase as the pH decreases. This comparison can be readily appreciated by graphically depicting the recorded viscosity versus pH data. Here the term “viscosity” means dynamic viscosity as measured at a temperature of 25 degrees Celsius (° C.) according to the following procedure (which is adapted from the procedure of ASTM D-3236): Using a Brookfield viscometer (e.g., a Brookfield DV-II+ Pro Extra digital viscometer), a spindle (spindle number is selected based on expected viscosity, where the greater the expected viscosity, the higher the spindle number is selected) of cylindrical or disc form, driven by a synchronous motor at a constant speed (typically 50 revolutions per minute (rpm)), is submersed in the aqueous APTP particles dispersion being studied. The resistance exerted by the aqueous polyolefin dispersion on the spindle is measured and digitally displayed on the Brookfield viscometer (Brookfield Engineering Laboratories, Middleboro, Mass., USA) This viscosity measurement procedure is used herein unless otherwise noted and is referred to herein for convenience as “PROCEDURE VM.”

The phrase “agglomeration-promotable amount” means a quantity that would be sufficient to enable gathering the polyolefin particles into a mass but for the presence of the dispersion desensitizer.

The phrase “agglomeration-prone thermoplastic polymer” means an organic material comprised of at least 7 repeat units, wherein each of the repeat units independently is a residual of a monomer, wherein each monomer is the same or different as another monomer and wherein the material turns to a liquid when heated at least to the higher of its glass transition temperature and melting temperature, and becomes a solid when cooled, wherein particles thereof are not readily dispersible in water in the absence of the dispersion-forming effective amount of the dispersing carboxylate salt (or ingredient (d)), and particles of an aqueous predispersion consisting of ingredients (a) to (c) and having pH 8.0 is naturally inclined to mass together under the would-be agglomeration condition in the absence of the agglomeration-inhibiting effective amount of the dispersion desensitizer and form a collected mass that has viscosity of greater than 2,000 cP. Preferably, the APTP has a maximum number average molecular weight of 10,000,000 grams per mole (g/mol) as determined by gel permeation chromatography (GPC) according to the GPC procedure described later.

In some embodiments the APTP is the polyolefin. As used herein, the term “polyolefin” means the organic material comprised of at least 7 repeat units, wherein each of the repeat units independently is a residual of a monomer, wherein each monomer is the same or different as another monomer and at least one, and preferably each, monomer contains at least one, preferably at most two, carbon-carbon triple bond or, preferably, carbon-carbon double bond.

The term “aliphatic radical” means an open-chain molecule wherein the chain is formed from at least 6 carbon atoms wherein the open chain is straight or branched, saturated or unsaturated, unsubstituted or substituted. Preferably, the aliphatic radical is saturated. In some embodiments the aliphatic radical is unsubstituted. In some embodiments the aliphatic radical is substituted with from 1 to 6 substituents as described previously. Preferably, the aliphatic radical (i.e., R) has from 6 to 59 carbon atoms, which is named herein as a (C₆-C₆₀)aliphatic radical.

The term “aqueous” means containing water as a liquid medium.

The term “carboxyl-containing” means having a —CO₂H or carboxylate (i.e., —CO₂⁻) functional group.

The term “dispersed” means distributed widely.

The term “dispersion desensitizer” means a substance or molecule that is capable of suppressing or preventing production of, delaying onset of production of, or stopping production of agglomerates of the APTP particles. Preferably, any agglomerates produced would make up at most 10 weight percent of the total weight of the APTP after 1 hour; or production of any agglomerates would be delayed by at least 1 hour; or any production of agglomerates occurring before adding ingredient (d) would be halted; or, preferably, a combination thereof.

The phrase “dispersion-forming effective amount” means a quantity sufficient to enable production of a wide distribution of the APTP particles in the water.

The term “formulated product” means a composition of matter not found in nature and containing at least two ingredients, wherein each of the at least two ingredients independently is present within an effective concentration range for the intended use of the formulated product.

The term “ingredient” means a substance added to, or to be added to, that which comprises, or is prepared from, the ingredient.

The phrase “inhibit agglomeration” means to prevent or suppress production of, delay onset of production of, or stop production of agglomerates. In some embodiments agglomeration of the APTP particles are inhibited in such a way that: the invention dispersion consisting of the mixture of ingredients (a) to (d) has a viscosity of less than 2,000 cP after 10 minutes, or the invention dispersion is prepared from such mixture; or production of any agglomerates would be delayed by at least 10 minutes; or any production of agglomerates occurring before adding ingredient (d) would be halted; or, preferably, a combination thereof.

The term “insensitive aqueous agglomeration-prone thermoplastic polymer dispersion” means a wide distribution of APTP particles in the water and substantially lacking agglomerates at a particular pH, extra metal cation content (composition, concentration, or both), or a combination thereof. In some embodiments the substantial lack of agglomerates can be qualitatively determined (e.g., by visual inspection of the distribution). In some embodiments the substantial lack of agglomerates can be quantitatively determined (e.g., by measuring viscosity of the distribution by PROCEDURE VM).

The term “manufactured product” means an article or composition of matter not found in nature that is suitable for its intended purpose.

The term “mixing” means an act comprising blending together.

The expression “mixture comprising” when preceding a list of ingredients of the mixture means a blend of the ingredients, a reaction product (e.g., acid-base reaction) of at least one of the ingredients (e.g., with another ingredient or a contaminant, if any, in the mixture), or a combination thereof.

The term “particle size volume mean” means dimension of particulates based on volume fraction at a temperature of 25° C., as determined using a Beckman Coulter LS230 Laser Diffraction Particle Size Analyzer with a Polarization Intensity Differential Scattering (PIDS) module and the following accessories: SVM+ (Small Volume Module Plus with sonic), Fluid Transfer Pump Kit (for SMV) and Software Version 3.29 according to the following procedure: A sample of dispersion is diluted in water, and the resulting dilute suspension is circulated through the path of the laser light and/or an incandescent tungsten-halogen light. Larger particles, if any, in the suspension scatter the laser light, forming a diffraction pattern that is filtered by a Fourier lens. Multiple photo detectors convert the detected light to an electric current that is transmitted to the software system for computations and data presentation. Smaller particles, if any, in the suspension are detected by light polarization, which uses the known Fraunhofer and Mie theories of light scattering by spherical particles to calculate particle size volume distribution and mean. The PIDS (Polarization Intensity Differential Scattering) Assembly in the Beckman Coulter LS230 uses an incandescent tungsten-halogen lamp and three sets of vertically and horizontally polarized filters to provide monochromatic light at wavelengths of 450 nanometers (nm; blue), 600 nm (orange), and 900 nm (near-infrared, invisible). The PIDS measures the pattern difference in scattering of vertically and horizontally oriented light to provide size information for particles in the 0.04 micrometer to 0.4 micrometer particle size range. This particle size measurement procedure can provide size information for particles in the 0.4 micrometer to 2,000 micrometers size range. The procedure is used herein unless otherwise noted and is referred to herein for convenience as “PROCEDURE PSM.”

The phrase “Periodic Table of the Elements” refers to the official periodic table, version dated Jun. 22, 2007, published by the International Union of Pure and Applied Chemistry (IUPAC). Also any references to a Group or Groups shall be to the Group or Groups reflected in this Periodic Table of the Elements.

The term “pH” means potential of hydrogen. The phrase “pH of less than pH 9.0” means a pH of at most pH 8.9900.

The term “pKa” means a negative logarithm in base 10 of an acid dissociation constant. The pKa of an unsubstituted alkanoic acid in water generally is about pKa 4.8 such that at pH 4.8, 50 mole percent of the alkanoic acid is said to be in the acid form (—COOH) and 50 mole percent in the conjugate base (—CO₂⁻) form.

As used herein, the term “would-be agglomeration condition” means a property of a material such as, for example, a chemical property (e.g., an ingredient, preferably other than ingredients (a) to (d), pH, or a combination thereof) that, but for the agglomeration-inhibiting effective amount of a dispersion desensitizer, would otherwise trigger or lead to gathering together of particles (e.g., APTP particles) into a mass. That is, the gathering together would occur in absence of the agglomeration-inhibiting effective amount of the dispersion desensitizer. Preferably, the material property is the chemical property, and more preferably a chemical property, or combination of at least two chemical properties, described in any one of the Examples of the Present Invention described later.

In some embodiments the would-be agglomeration condition comprises a pH of less than pH 9.0 (in some embodiments the pH is from greater than 1.0 to less than pH 9.0) and the invention dispersion or formulation mixture has the pH <9.0, and the dispersion desensitizer functions in such a way so as to inhibit pH-sensitive agglomeration of the agglomeration-prone thermoplastic polymer (APTP) particles. In some embodiments the would-be agglomeration condition comprises an agglomeration-promotable amount of an extra metal cation, wherein the extra metal cation is derived from an ingredient other than ingredients (b) to (d), and the invention dispersion or formulation mixture contains the agglomeration-promotable amount of the extra metal cation; and the dispersion desensitizer functions in such a way so as to inhibit metal cation content-sensitive agglomeration of the APTP particles. In some embodiments the extra metal cation is derived from the water (ingredient (a)). In some embodiments the extra metal cation is derived from a non-dispersing additive containing metal cations (i.e., metal cations from an additive other than a dispersing agent) and the invention dispersion or formulation mixture further comprises the non-dispersing additive.

In some embodiments the would-be agglomeration condition comprises the pH of less than pH 9.0 and the agglomeration-promotable amount of an extra metal cation, and the invention dispersion or formulation mixture has the pH less than pH 9.0 and contains the agglomeration-promotable amount of the extra metal cation, and the dispersion desensitizer functions in such a way so as to inhibit pH-sensitive agglomeration and metal cation content-sensitive agglomeration of the APTP particles.

Advantageously, the invention dispersion is pH, metal cation, or preferably pH and metal cation insensitive. Without being bound by theory, it is believe that this insensitivity is due to the functioning of the dispersion desensitizer. The dispersion desensitizer works with any salt of the dispersing carboxylate and with or without using a polar group-containing polymer as an additional dispersion forming agent in the invention dispersions. Adding the agglomeration-inhibiting effective amount of the dispersion desensitizer to an aqueous APTP predispersion comprising ingredients (a) to (c) according to the invention method forms the invention dispersion. In some embodiments the contacting step includes the would-be agglomeration condition. In other embodiments the contacting step forms a mixture lacking the would-be agglomeration condition (e.g., a mixture at pH>pH 9.0, lacking sufficient extra metal cation content, or both), and the invention method further comprises subjecting the resulting mixture to the would-be agglomeration condition so as to form the invention dispersion. When pH of the invention dispersion drops below pH 9, when the invention dispersion also contains the agglomeration-promotable amount of the extra metal cations, or, both, agglomerates formation therein is inhibited. Thus, the invention dispersion is useful as an ingredient in the invention formulated product, even the invention formulated product having a pH of less than pH 9, including less than pH 8.5; containing the non-dispersing additive containing metal cations; or, in some embodiments, both. If desired the invention dispersion can be organic solvent free, have a high solids content (e.g., >50 weight percent (wt %), e.g., 75 wt %), or both.

The invention dispersion is useful for preparing the invention formulated and manufactured products. The invention manufactured product can be targeted to any one of many uses in the thermoplastic polymer (e.g., polyolefin) art such as, for example, as the coated textile, coated paper, packaging material, a layer of a laminated composite, or a conduit for conducting a gas or liquid. The invention formulated product can be targeted to any one of many uses in the thermoplastic polymer (e.g., polyolefin) dispersion art such as, for example, for cleaning hair (human or animal hair), skin applications (human or animal), softening leather, or as an ingredient (e.g., a releasing agent) of adhesives. The invention contemplates additional uses for the invention dispersion, manufactured product, and formulated product that are not listed herein.

Additional embodiments are described in accompanying drawing(s) and the remainder of the specification, including the claims.

### BRIEF DESCRIPTION OF THE DRAWING(S)

Some embodiments of the present invention are described herein in relation to the accompanying drawing(s), which will at least assist in illustrating various features of the embodiments.

FIG. 1 shows a melt-kneader apparatus useful in the present invention method.

### DETAILED DESCRIPTION OF THE INVENTION

The invention relates to the insensitive aqueous agglomeration-prone thermoplastic polymer dispersion containing ingredients that include, among other things, a dispersion desensitizer, methods of use thereof, and manufactured articles and formulated products prepared therefrom summarized previously and incorporated here by reference.

For purposes of United States patent practice and other patent practices allowing incorporation of subject matter by reference, the entire contents—unless otherwise indicated—of each U.S. patent, U.S. patent application, U.S. patent application publication, PCT international patent application and WO publication equivalent thereof, referenced in the instant Summary or Detailed Description of the Invention are hereby incorporated by reference. In an event where there is a conflict between what is written in the present specification and what is written in a patent, patent application, or patent application publication, or a portion thereof that is incorporated by reference, what is written in the present specification controls.

In the present application, any lower limit of a range of numbers, or any preferred lower limit of the range, may be combined with any upper limit of the range, or any preferred upper limit of the range, to define a preferred aspect or embodiment of the range. Unless otherwise indicated, each range of numbers includes all numbers, both rational and irrational numbers, subsumed within that range (e.g., the range from about 1 to about 5 includes, for example, 1, 1.5, 2, 2.75, 3, 3.80, 4, and 5).

The word “optionally” means “with or without.” For example, “optionally, an additive” means with or without an additive. The term “substantially” preferably means at least 90%, preferably at least 95%, and more preferably at least 98%.

In an event where there is a conflict between a compound name and its structure, the structure controls.

In an event where there is a conflict between a unit value that is recited without parentheses, e.g., 2 inches, and a corresponding unit value that is parenthetically recited, e.g., (5 centimeters), the unit value recited without parentheses controls.

As used herein, “a,” “an,” and “the,” are used following an open-ended term such as comprising to mean “at least one.” In any aspect or embodiment of the instant invention described herein, the term “about” in a phrase referring to a numerical value may be deleted from the phrase to give another aspect or embodiment of the instant invention. In the former aspects or embodiments employing the term “about,” meaning of “about” can be construed from context of its use. Preferably “about” means from 90 percent to 100 percent of the numerical value, from 100 percent to 110 percent of the numerical value, or from 90 percent to 110 percent of the numerical value. In any aspect or embodiment of the instant invention described herein, the open-ended terms “comprising,” “comprises,” and the like (which are synonymous with “including,” “having,” and “characterized by”) may be replaced by the respective partially closed phrases “consisting essentially of,” “consists essentially of,” and the like or the respective closed phrases “consisting of,” “consists of,” and the like to give another aspect or embodiment of the instant invention. The partially closed phrases such as “consisting essentially of” and the like limits scope of a claim to materials or steps recited therein and those that do not materially affect the basic and novel characteristic(s) of the claimed invention. The term “characterizable” is open-ended and means distinguishable, if desired, and preferably means is distinguished as described.

In the present application, when referring to a preceding list of elements (e.g., ingredients), the phrases “mixture thereof,” “combination thereof,” and the like mean any two or more, including all, of the listed elements. The term “or” used in a listing of members, unless stated otherwise, refers to the listed members individually as well as in any combination, and supports additional embodiments reciting any one of the individual members (e.g., in an embodiment reciting the phrase “10 percent or more,” the “or” supports another embodiment reciting “10 percent” and still another embodiment reciting “more than 10 percent.”). The term “plurality” means two or more, wherein each plurality is independently selected unless indicated otherwise. The term “independently” means separately without regard for another. The terms “first,” “second,” et cetera serve as a convenient means of distinguishing between two or more elements or limitations (e.g., a first chair and a second chair) and do not imply quantity or order unless specifically so indicated. The symbols “≦” and “≧” respectively mean less than or equal to and greater than or equal to. The symbols “<” and “>” respectively mean less than and greater than. The term “characterizable” means capable of being distinguished, if desired.

Any headings herein are used only for convenience of the reader and do not limit, and should not be interpreted as limiting, the present invention.

Where the invention, or a portion thereof (e.g., element or step), is defined in the alternative by a Markush group having two or more members, the invention contemplates preferred embodiments too numerous to recite each one herein. For convenience, such preferred embodiments can be readily determined by: (i) selecting any single member from the Markush group, thereby limiting scope of the Markush group to the selected single member thereof; or (ii) deleting any single member from the Markush group, thereby limiting the Markush group to any one of the remaining member(s) thereof. In some embodiments the member that is selected or deleted is based on one of the Examples or other species of the present invention described herein.

This specification may refer to certain well-known testing standards promulgated by certain organizations, which are referred to herein by their acronyms. The acronym “ANSI” stands for American National Standards Institute, the name of an organization headquartered in Washington, D.C., USA. The acronym “ASTM” stands for ASTM International, the name of an organization headquartered in West Conshohocken, Pa., USA; ASTM International was previously known as the American Society for Testing and Materials. The acronym “DIN” stands for Deutsches Institut für Normung e. V., the name of an organization headquartered in Berlin, Germany. The acronym “ISO” stands for International Organization for Standardization, the name of an organization headquartered in Geneva 20, Switzerland.

As mentioned previously, the invention dispersion comprises ingredients water (ingredient (a)), the APTP particles (ingredient (b)), dispersing carboxylate salt (ingredient (c)), and dispersion desensitizer (ingredient (d)). In some embodiments the invention dispersion is characterized by at least one of its following characteristics: concentration of ingredients; solids content; pH; composition or concentration of extra metal cations, if any, in the invention dispersion; viscosity; and composition, size, or size distribution of the ingredients.

In the invention dispersion, preferably ingredients (b) to (d) are present in the following concentration ranges:

Ingredient (b): APTP particles concentration is from 1 wt % to 78 wt %, preferably, from 31 wt % to 69 wt %, and more preferably from 40 wt % to 50 wt % of the invention dispersion, based on total weight of the invention dispersion;

Ingredient (c): dispersing carboxylate salt concentration is from 0.5 wt % to 20 wt % of the invention dispersion, based on combined weight of the APTP particles plus dispersing carboxylate salt; and

Ingredient (d): dispersion desensitizer concentration is from 0.05 wt % to 20 wt % of the invention dispersion, based on combined weight of the APTP particles plus dispersion desensitizer.

The water (ingredient (a)) makes up any balance weight percent concentration of the invention dispersion. In some embodiments where when the invention dispersion further comprises at least one additional dispersion ingredient other than ingredients (a) to (d), or the invention dispersion is an ingredient of the invention formulated product, the water makes up the balance weight percent concentration after accounting for the at least one additional dispersion ingredient or the at least one additional formulation ingredient of the formulated product. Preferably, water is from 50 wt % to 60 wt % of the invention dispersion. Using the relative concentrations of the dispersing carboxylate salt and dispersion desensitizer and the absolute concentrations of the APTP particles and water, the absolute concentrations of the former two ingredients, and any additional dispersion ingredients, in the invention dispersion can be readily determined. Using the absolute concentration of the ingredients (a) to (d) and any additional dispersion ingredients of the invention dispersion, and concentration of the at least one additional formulation ingredient, their concentrations in the formulated product can be readily determined. In some embodiments the concentrations of ingredients of the invention dispersion is as defined in any one of the Examples of the Present Invention described later.

In some embodiments the invention dispersion is characterized by its volume percent (vol %) solids content. In some embodiments the invention dispersion has a maximum vol % solids content of 75 vol %, preferably less than 70 vol %, more preferably less than 65 vol %, and still more preferably less than 55 vol %. In some embodiments the invention dispersion has a minimum vol % solids content of at least 4 vol %, preferably at least 10 vol %, more preferably at least 20 vol %, and still more preferably at least 40 vol %. In some embodiments the invention dispersion has a minimum vol % solids content of from 40 vol % to 50 vol %. In some embodiments the vol % solids content of the invention dispersion is as defined in any one of the Examples of the Present Invention described later.

In some embodiments the invention dispersion is characterized by its pH. In some embodiments the invention dispersion has a maximum pH of pH 8.8; in some embodiments pH 8.0; in some embodiments pH 7.0; in some embodiments pH 6.0; and in some embodiments pH 5.0. In some embodiments the invention dispersion has a minimum pH of pH 1.0 (or >pH 1.0); in some embodiments pH 1.4; in some embodiments pH 2.0; in some embodiments pH 3.0; and in some embodiments pH 4.0. In some embodiments the pH of the invention dispersion is as defined in any one of the Examples of the Present Invention described later.

In some embodiments the invention dispersion is characterized by its extra metal cation content. The term “content” in this context means composition, concentration, or both of the extra metal cation. The term “extra metal cation” means a cation derived from an ingredient of the invention dispersion or formulated product other than ingredients (b) to (d) or any additional dispersing agent as defined herein. If any one, two or all of ingredients (b) to (d) contain metal cations, the metal cations thereof do not count as the extra metal cation. In some embodiments the extra metal cation is a Group 2 metal cation, preferably a magnesium or calcium cation. In some embodiments the extra metal cation is a so-called heavy metal cation, and more preferably a cation of aluminum, iron, or titanium. In some embodiments the extra metal cation is added to the invention dispersion in form of a metal salt. In some embodiments the metal salt comprises the extra metal cation and an anion that is a halide (e.g., fluoride, chloride, or bromide), carbonate, hydroxide, or oxide. In some embodiments the extra metal cation is sourced from the water (ingredient (a)). In some embodiments the invention dispersion is characterized by its extra metal cation concentration. When the would-be agglomeration condition comprises the extra metal cation content, concentration thereof is sufficient to give the agglomeration promotable amount. In some embodiments the extra metal cation concentration is from >0 mole percent (mol %) to less than mole percent concentration of the dispersion desensitizer. In such embodiments, preferably the extra metal cation concentration is from >0 wt % to 5 wt %, more preferably from >0 wt % to 2; still more preferably from >0 wt % to 1; and even more preferably from >0 wt % to 0.5 wt %. In some embodiments the extra metal cation content of the invention dispersion is as defined in any one of the Examples of the Present Invention described later.

In some embodiments the invention dispersion is characterized by its viscosity as measured using PROCEDURE VM In some embodiments the invention dispersion at pH 8.0 has a viscosity of is less than 1000 cP, in some embodiments less than 600 cP, in some embodiments less than 200, and in some embodiments less than 100 cP. In some embodiments the invention dispersion has a viscosity of less than 1000 cP at a pH of, increasingly preferably, pH 7.0, pH 6.0, pH 5.0, pH 4.0, pH 3.0, pH 2.0, or pH 1.2. In some embodiments the invention dispersion has a viscosity of less than 500 cP at a pH of, increasingly preferably, pH 7.0, pH 6.0, pH 5.0, pH 4.0, pH 3.0, pH 2.0, or pH 1.2. In some embodiments the invention dispersion has a viscosity of less than 300 cP at a pH of, increasingly preferably, pH 7.0, pH 6.0, pH 5.0, pH 4.0, pH 3.0, pH 2.0, or pH 1.2. In some embodiments the invention dispersion has a viscosity of less than 100 cP at a pH of, increasingly preferably, pH 7.0, pH 6.0, pH 5.0, pH 4.0, pH 3.0, pH 2.0, or pH 1.2. In some embodiments the viscosity of the invention dispersion is as defined in any one of the Examples of the Present Invention described later.

In some embodiments the invention dispersion is characterized by a combination of any two of the aforementioned characteristics of ingredients concentration, vol % solids content, pH, extra metal cation content, and viscosity. A preferred combination is pH and viscosity. Another preferred combination is extra metal cation content and viscosity. Still another preferred combination is pH, extra metal cation content, and viscosity.

The ingredients of the invention dispersion and products prepared therefrom include solvates, including hydrates, thereof.

The ingredient (a) is water. In some embodiments the water comprises a naturally-occurring water such as water from a fresh water lake or river. In some embodiments the water comprises a water recycled from an industrial wastewater, e.g., wastewater from an APTP dispersion manufacturing process. In some embodiments the water comprises potable water, e.g., tap water. In some embodiments the water is purified water. More preferably, the water is purified water that is distilled water or, still more preferably, deionized water. If desired, metal cation content (composition and concentration) of the water, especially calcium and magnesium cation content, can be readily determined according to ASTM D511-09.

The ingredient (b) is the APTP particles. In some embodiments the APTP particles are characterized by their particle size volume mean, which preferably is less than 10 microns according to PROCEDURE PSM. Typically the particle size volume mean is at most 5 microns. In some embodiments the APTP particles have a maximum particle size volume mean of 4 microns, in some embodiments 3 microns, in some embodiments 2 microns, in some embodiments 1.5 microns, and in some embodiments 1.0 micron. In some embodiments the APTP particles have a minimum particles size volume mean, which typically is at least 0.05 micron. In some embodiments the APTP particles have a minimum particle size volume mean of 0.07 micron, in some embodiments 0.10 micron, in some embodiments 0.5 micron, in some embodiments 1.0 micron, and in some embodiments 2.0 microns. In some embodiments the APTP particles have a particle size volume mean of from 0.05 micron to 1.5 microns, and in other embodiments from 0.5 micron to 1.5 microns. The agglomeration-inhibiting effective amount of the dispersion desensitizer can be readily adjusted higher or lower depending on the particle size volume mean of the APTP particles.

In some embodiments the APTP particles are characterized by their particle size distribution. The term “particle size distribution” means the value equal to volume average particle diameter (Dv) divided by number average particle diameter (Dn) according to PROCEDURE PSM. In some embodiments the APTP particles are characterized by a particle size distribution of less than or equal to 2.0; in some embodiments less than 1.95; in some embodiments less than 1.75; and in some embodiments less than 1.5.

In some embodiments the APTP particles are characterized by their particle size range. In some embodiments the particle size range is from 0.05 micron to 5 microns, and in some embodiments from 0.3 micron to 2 microns according to PROCEDURE PSM.

In some embodiments the agglomeration-prone thermoplastic polymer is a polyolefin and the APTP particles are polyolefin particles. In some embodiments the polyolefin particles are characterized by their polyolefin composition, which in some embodiments includes a single type of polyolefin and a mixture or blend of at least two polyolefins. In some dispersions the polyolefin is an alpha-olefin interpolymer of ethylene with at least one olefin comonomer selected from the group consisting of a (C₄-C₂₀) linear, branched or cyclic diene, or an ethylene vinyl compound, such as vinyl acetate, and a compound represented by the formula H₂C═CHR wherein R is a (C₁-C₂₀) linear, branched or cyclic alkyl group or a (C₆-C₂₀)aryl group. Preferred olefin comonomers include propylene, 1-butene, 3-methyl-1-butene, 4-methyl-1-pentene, 3-methyl-1-pentene, 1-heptene, 1-hexene, 1-octene, 1-decene, and 1-dodecene. Other preferred olefin comonomers are 1,3-butadiene, styrene, or a both. In some embodiments the olefin monomer (and the polyolefin) is unsubstituted, i.e., consists of carbon and hydrogen atoms. In other embodiments the olefin monomer is substituted by fluoro (e.g., vinyl fluoride), chloro (e.g., vinyl chloride and vinylidene chloride), nitrile (—CN; e.g., acrylonitrile), —OH (e.g., vinyl alcohol), —COOH (e.g., acrylic and methacrylic acids), or —C(O)O-methyl (e.g., methyl methacrylate) or —C(O)O-ethyl (ethyl acrylate).

In other embodiments, the polyolefin comprises an alpha-olefin interpolymer of propylene with at least one olefin comonomer selected from the group consisting of ethylene, a (C₄-C₂₀) linear, branched or cyclic diene, and a compound represented by the formula H₂C═CHR wherein R is a (C₁-C₂₀) linear, branched or cyclic alkyl group or a (C₆-C₂₀)aryl group. Preferred olefin comonomers are listed previously. In some embodiments, the olefin comonomer is present at about percent by weight to about 25 percent by weight of the interpolymer. In some embodiments, a propylene-ethylene interpolymer is preferred.

In some embodiments the polyolefin comprises any one polyolefin described in paragraphs [0016] to [0019], [0045], [0055] to [0125], and [0153] to [0159], of US 2007/0292705 A1, which paragraphs (and only these) are hereby incorporated by reference here.

In some embodiments the polyolefin is an ethylene-1-octene copolymer (a polyolefin elastomer) that is supplied in pellet form under trade name ENGAGE® 8200 by The Dow Chemical Company, Midland, Mich., USA and has various properties listed later. In other embodiments the ENGAGE® 8200 is blended with polypropylene (PP) or polyethylene (PE) to give an ENGAGE® 8200/PP or ENGAGE® 8200/PE blend. In some embodiments the polyolefin particles are as defined in any one of the Examples of the Present Invention described later.

In some embodiments the agglomeration-prone thermoplastic polymer is other than a polyolefin and the APTP particles are non-polyolefin APTP particles. In some embodiments the APTP is, and the non-polyolefin APTP particles are particles of, a polyamide, polyester, polyesterether, polycarbonate, polyurethane, poly(alkylene oxide), or poly(phenylene oxide).

Preferably, the APTP is obtained from a commercial supplier (e.g., The Dow Chemical Company, Midland, Mich., USA). If necessary, APTP can be readily prepared by conventional means such as those described in U.S. Pat. No. 3,645,992 (homogeneous polymers); U.S. Pat. No. 4,076,698 (high density polyethylene); and U.S. Pat. No. 5,272,236 and U.S. Pat. No. 5,278,272 (ethylene/alpha-olefin copolymers). Other suitable polymer preparations are described in U.S. Pat. Nos. 5,677,383; 5,844,045; U.S. Pat. No. 5,869,575; U.S. Pat. No. 6,111,023; U.S. Pat. No. 6,316,549; U.S. Pat. No. 6,448,341; U.S. Pat. No. 6,538,070; and U.S. Pat. No. 6,566,446.

The ingredient (c) is the dispersing carboxylate salt. In some embodiments the dispersing carboxylate salt is the cation salt of the anion, R—CO₂⁻. In some embodiments concentration of the cation salt of the anion, R—CO₂⁻ is from 0.5 wt % to 10 wt % of the invention dispersion, based on combined weight of the APTP particles plus dispersing carboxylate salt. In some embodiments the dispersing carboxylate salt comprises an ammonium (—NH₄⁺), a mono-, di-, tri-, or tetra-(C₁-C₆₀)alkyl substituted ammonium cation salt of (C₆-C₆₀)alkanoate or a Group 1 or 2 metal cation salt of a (C₆-C₆₀)alkanoate. In some embodiments the dispersing carboxylate salt comprises the Group 1 or 2 metal cation salt of a (C₆-C₆₀)alkanoate. The term “(C₆-C₆₀)alkanoate” means a conjugate base (i.e., having —CO₂ anion) of an aliphatic carboxylic acid of from 6 to 60 total carbon atoms. In some embodiments the (C₆-C₆₀)alkanoate is (C₁₂-C₅₀)alkanoate, in some embodiments (C₂₅-C₅₀)alkanoate, in some embodiments (C₁₂-C₃₀)alkanoate, in some embodiments (C₁₂-C₂₄)alkanoate, and in some embodiments (C₁₆-C₂₆)alkanoate. In other embodiments (C₆-C₆₀)alkanoate is any one of (C₁₅)alkyl-CO₂ anion, (C₁₆)alkyl-CO₂ anion, (C₁₇)alkyl-CO₂ anion, (C₁₈)alkyl-CO₂ anion, (C₁₉)alkyl-CO₂ anion, (C₂₀)alkyl-CO₂ anion, (C₂₁)alkyl-CO₂ anion, (C₂₂)alkyl-CO₂ anion, (C₂₃)alkyl-CO₂ anion, (C₂₄)alkyl-CO₂ anion, and (C₂₅)alkyl-CO₂ anion. In some embodiments (C₆-C₆₀)alkanoate (C₂₁)alkyl-CO₂ anion. In some embodiments the Group 1 or 2 metal cation is a Group 1 metal cation. In some embodiments the Group 1 metal cation is sodium cation or potassium cation. In some embodiments the Group 1 or 2 metal cation is a Group 2 metal cation. In some embodiments the Group 2 metal cation is magnesium cation or calcium cation. The Group 2 metal cation salts of (C₆-C₆₀)alkanoate include 1:1 and hemi salts. For example, the Group 2 metal cation salts of (C₆-C₆₀)alkanoate include salts of the formula (C₅-C₅₉)alkyl-CO₂Ca(OH) and [(C₅-C₅₉)alkyl-CO₂]₂Ca. A preferred Group 1 or 2 metal cation salt of (C₆-C₆₀)alkanoate is sodium behenoate (i.e., CH₃(CH₂)₂₀CO₂Na) or sodium erucoate, the sodium salt of erucic acid, which has 22 carbon atoms. In some embodiments the erucoate salt is derived from rapeseed oil, a natural oil that contains approximately 40 to about 50 percent erucic acid with the remainder primarily consisting of carboxylic acids having 18 carbon atoms. In some embodiments the dispersing carboxylate salt is a (C₁₈-C₃₂) fatty acid neutralized with a base (typically, NaOH, KOH, or NH₄OH). One particular example of this type is oleic acid (i.e., CH₃(CH₂)₇CH═CH(CH₂)₇COOH) neutralized with KOH.

In some embodiments the dispersing carboxylate salt comprises an ammonium (—NH₄⁺), a mono-, di-, tri-, or tetra-(C₁-C₆₀)alkyl substituted ammonium cation salt of (C₆-C₆₀)alkanoate, wherein (C₆-C₆₀)alkanoate is as described previously. In some embodiments the cation is ammonium cation. In some embodiments the cation is the mono(C₁-C₆₀)alkyl substituted ammonium cation. In some embodiments the cation is the di(C₁-C₆₀)alkyl substituted ammonium cation. In some embodiments the cation is the tri(C₁-C₆₀)alkyl substituted ammonium cation. In some embodiments the cation is the tetra(C₁-C₆₀)alkyl substituted ammonium cation. In some embodiments each (C₁-C₆₀)alkyl independently is (C₁-C₁₀)alkyl. In some embodiments each (C₁-C₁₀)alkyl independently is a preferred (C₁-C₁₀)alkyl described previously.

In some embodiments the dispersing carboxylate salt comprises the multi-cation salt of the carboxylic acid polymer. The carboxyl-containing monomer residuals independently are derived from the at least one carboxyl-containing monomer. In some embodiments the carboxylic acid polymer (as its multi-cation salt) consists of residuals of the at least one carboxyl-containing monomer and does not contain residuals derived from monomers lacking a carboxyl group. In other embodiments the carboxylic acid polymer (as its multi-cation salt) comprises residuals derived from the at least one carboxyl-containing monomer (e.g., acrylic acid) and at least one monomer (e.g., ethylene) that lacks a carboxyl group. In some such embodiments the invention dispersion contains at least 1.2 wt %, in other embodiments at least 1.5 wt %, and in other embodiments at least 1.6 wt % of carboxyl-containing monomer residuals. In some such embodiments the invention dispersion contains at most 20 wt %, in other embodiments at most 15 wt %, in still other embodiments at most 10 wt %, and in even other embodiments at most 7 wt % of carboxyl-containing monomer residuals. The wt % values in the preceding two sentences are based on ratio of weight of the carboxyl-containing monomer residuals to combined weight of ingredient (b) plus weight of the multi-cation salt of the carboxylic acid polymer. In some embodiments concentration of the carboxylic acid polymer (as its multi-cation salt) is from 0.5 wt % to 20 wt % of the invention dispersion, preferably from 5 wt % to 18 wt %, and more preferably from 8 wt % to 15 wt %, based on combined weight of the APTP particles plus dispersing carboxylate salt. Preferably, the multi-cation salt of the carboxylic acid polymer has a maximum number average molecular weight of 10,000,000 grams per mole (g/mol) as determined according to the GPC procedure described later. In some embodiments the at least one carboxyl-containing monomer is acrylic acid or an acrylic acid substituted on at least one carbon atom with methyl or ethyl. In some embodiments the at least one carboxyl-containing monomer is acrylic acid or methacrylic acid. In some embodiments the carboxylic acid polymer further comprises residuals of an olefinic monomer. In some embodiments the olefinic monomer is styrene, (C₄-C₁₀)alpha-olefin, more preferably propylene, and still more preferably ethylene. In some embodiments the multi-cation salt of the carboxylic acid polymer is a poly(propylene-co-acrylic acid), more preferably a poly(ethylene-co-methacrylic acid), and still more preferably a poly(ethylene-co-acrylic acid). In some embodiments the multi-cation salt of the carboxylic acid polymer is the poly(ethylene-co-acrylic acid) that is sold by The Dow Chemical Company under the trade name PRIMACOR®, and more preferably PRIMACOR® 5980I (20 wt % acrylic acid residual, 300 MI). In some embodiments the APTP is a polyolefin and the amount of PRIMACOR® 5980I is from 8 wt % to 15 wt % based on ratio of weight of PRIMACOR® 5980I to combined weights of PRIMACOR® 5980I and polyolefin; and the amount of carboxyl-containing monomer residuals is from 1.6 wt % to 3 wt % ((8 wt % times 0.20) to (15 wt % times 0.20)), based on ratio of weight of the acrylic acid residuals to combined weight of the polyolefin plus weight of the PRIMACOR® 5980I.

Preferably, the dispersing carboxylate salt is obtained from a commercial supplier (e.g., Sigma-Aldrich Company, St. Louis, Mo., USA). If necessary, the dispersing carboxylate salt can be prepared by neutralizing the corresponding carboxylic acid (conjugate acid, e.g., PRIMACOR® 5980I or (C₆-C₆₀)alkanoic acid) with a Group 1 or 2 metal cation base such as, for example, sodium or potassium hydroxide or calcium carbonate or with an ammonium hydroxide or various (C₁-C₆₀)alkyl substituted ammonium hydroxides. Alternatively, the dispersing carboxylate Group 1 or 2 metal cation salt can be prepared by saponifying a corresponding carboxylic ester thereof with a Group 1 or 2 metal cation hydroxide. In some embodiments the R— or carboxylic polymer of the dispersing carboxylate salt is derived from sustainable sources. For example, in some embodiments dispersing carboxylate is a fatty acid carboxylate derived from or based on a naturally-occurring fatty carboxylic acid. Naturally-occurring fatty carboxylic acids can be prepared, for example, by saponifying triglycerides obtained from animal or, preferably, plant sources. Examples of commercially available fatty carboxylic acids are UNCID™ 350, 550, and 700 Acids, which have carbon chain lengths of from 25 to 50 carbon atoms and are available from Baker Petrolite Corporation, a division of Baker Hughes Incorporated, Houston, Tex., USA. The UNCID™ 350, 550, and 700 Acids are approximately 80% linear and 20% polyethylene. In some embodiments the dispersing carboxylate salt is as defined in any one of the Examples of the Present Invention described later.

The ingredient (d) is the dispersion desensitizer. The dispersion desensitizer can be any substance or molecule that functions as defined previously for functioning of the dispersion desensitizer. The dispersion desensitizer and the dispersing carboxylate salt are different.

In some embodiments the dispersion desensitizer is a zwitterionic compound containing the following functional groups: a quaternary ammonium or quaternary phosphonium functionality; a (C₆-C₃₀)alkyl, (C₆-C₃₀)alkenyl, (C₆-C₃₀)alkylC(O)NH— functionality; and a —COOH or —COO anion salt functionality.

In some embodiments the dispersion desensitizer is a compound of formula (I):

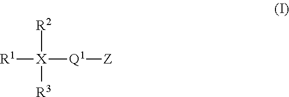

Wherein: X is N cation or P cation; Z is —CO₂ anion, —SO₃ anion, —O—P(O)₂OH anion, —O—P(O)₃ dianion, or —O—S(O)₃ anion; Each of R² and R³ independently is (C₁-C₁₀)alkyl or (C₂-C₁₀)alkenyl; R¹ is (C₆-C₃₀)alkyl, (C₆-C₃₀)alkenyl, or R⁴—C(O)N(H)-Q²-; Each of Q¹ and Q² independently is (C₁-C₁₀)alkylene; and R⁴ is (C₆-C₃₀)alkyl. The compound of formula (I) is overall formally neutral.

In formula (I), the terms “(C₆-C₃₀)alkylenyl” and “(C₂-C₁₀)alkenyl” mean an unsaturated straight or branched hydrocarbon radical of from 6 to 30 or 2 to 10 carbon atoms, respectively, that is unsubstituted and contains from 1 to 3 carbon-carbon double bonds, not including cumulenes.

The terms “(C₆-C₃₀)alkyl” and “(C₁-C₁₀)alkyl” mean a saturated straight or branched hydrocarbon radical of from 6 to 30 carbon atoms or from 1 to 10 carbon atoms, respectively, that is unsubstituted. Other alkyl groups (e.g., (C₁₀-C₂₂)alkyl and (C₁₂-C₂₂)alkyl)) are defined in an analogous manner. In some embodiments (C₁₀-C₂₂)alkyl is any one of (C₁₀)alkyl, (C₁₁)alkyl, (C₁₂)alkyl, (C₁₃)alkyl, (C₁₄)alkyl, (C₁₅)alkyl, (C₁₆)alkyl, (C₁₇)alkyl, (C₁₈)alkyl, (C₁₉)alkyl, (C₂₀)alkyl, (C₂₁)alkyl, and (C₂₂)alkyl. Examples of (C₁-C₁₀)alkyl are (C₁-C₅)alkyl; methyl; ethyl; 1-propyl; 2-propyl; 1-butyl; 2-butyl; 2-methylpropyl; 1,1-dimethylethyl; 1-pentyl; 1-hexyl; 1-heptyl; 1-nonyl; and 1-decyl. Examples of (C₆-C₃₀)alkyl are (C₆-C₁₁)alkyl, (C₁₂-C₂₂)alkyl, and (C₂₃-C₃₀)alkyl. Examples of (C₁₂-C₂₂)alkyl are (C₁₂)alkyl, (C₁₃)alkyl, (C₁₄)alkyl, (C₁₅)alkyl, (C₁₆)alkyl, (C₁₇)alkyl, (C₁₈)alkyl, (C₁₉)alkyl, (C₂₀)alkyl, (C₂₁)alkyl, and (C₂₂)alkyl.

The term “(C₁-C₁₀)alkylene” means a saturated straight chain or branched chain diradical (i.e., the radicals are not on ring atoms) of from 1 to 10 carbon atoms that is unsubstituted. Examples of (C₁-C₁₀)alkylene are (C₁-C₅)alkylene, including 1,2-(C₂-C₅)alkylene; 1,3-(C₃-C₅)alkylene; 1,4-(C₄-C₅)alkylene, —CH₂—, —CH₂CH₂—, —(CH₂)₃—,

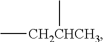

### —(CH₂)₄—, —(CH₂)₅—, —(CH₂)₆—, —(CH₂)₇—, —(CH₂)₈—, and —(CH₂)₄C(H)(CH₃)—.

For convenience, some of the functional groups described herein employ parentheses ( ) to indicate atoms that are not in a chain of atoms. For example, the diradical “—C(O)N(H)—” means a carboxamido diradical of the following structure:

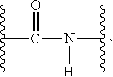

wherein each

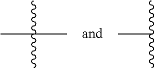

indicates a radical. Likewise, the —O—P(O)₂OH anion and —O—P(O)₃ dianion mean phosphate anion and phosphate dianion, respectively; and the —O—S(O)₃ anion means a sulfate anion. Unless otherwise noted, the term “radical” refers to a formal point of attachment or bonding of a functional group in a molecule containing the functional group. For example, a “diradical” refers to two such formal points of attachment or bonding.

In some embodiments the dispersion desensitizer is the compound of formula (I) wherein X is N cation. In other embodiments X is P cation.

In some embodiments the dispersion desensitizer is the compound of formula (I) wherein Z is —CO₂ anion. In other embodiments Z is SO₃ anion. In other embodiments Z is —O—P(O)₂OH anion. In other embodiments Z is —O—P(O)₃ dianion. In other embodiments Z is —O—S(O)₃ anion.

In some embodiments the dispersion desensitizer is the compound of formula (I) wherein R¹ is (C₆-C₃₀)alkyl. In some embodiments R¹ is (C₁₂-C₂₂)alkyl.

In some embodiments the dispersion desensitizer is the compound of formula (I) wherein R¹ is (C₆-C₃₀)alkenyl. In some embodiments R¹ is (C₁₂-C₂₂)alkylenyl.

In some embodiments the dispersion desensitizer is the compound of formula (I) wherein Q¹ is (C₁-C₅)alkylene. In some embodiments Q¹ is any one of —CH₂—, —CH₂CH₂—, —(CH₂)₃—, —(CH₂)₄—, and —(CH₂)₅—. In some embodiments Q¹ is —CH₂— or —CH₂CH₂—.

In some embodiments the dispersion desensitizer is the compound of formula (I) wherein R¹ is R⁴—C(O)N(H)-Q²-. In some embodiments R⁴ is (C₁₀-C₂₂)alkyl.

In some embodiments the dispersion desensitizer is the compound of formula (I) wherein R¹ is R⁴—C(O)N(H)-Q²- and Q² is (C₂-C₆)alkylene, in some embodiments (C₂-C₃)alkylene, and in some embodiments (C₃)alkylene, which preferably is —(CH₂)₃—. In some embodiments R⁴ is a preferred R⁴ as described in the immediately preceding paragraph.

In some embodiments the dispersion desensitizer is the compound of formula (I) wherein each of R² and R³ independently is (C₁-C₁₀)alkyl. In some embodiments each of R² and R³ independently is (C₁-C₃)alkyl, and preferably methyl.

In some embodiments the dispersion desensitizer is the compound of formula (I) wherein each of R² and R³ independently is (C₂-C₁₀)alkenyl. In some embodiments each of R² and R³ independently is (C₂-C₄)alkenyl.

In some embodiments the dispersion desensitizer is the compound of formula (I) wherein: X is N cation; Z is —CO₂ anion; R¹ is (C₆-C₃₀)alkyl; Q¹ is (C₁-C₅)alkylene; and each of R² and R³ independently is (C₁-C₁₀)alkyl. In some such embodiments X is N cation; Z is —CO₂ anion; R¹ is (C₁₂-C₂₂)alkyl; Q¹ is any one of —CH₂—, —CH₂CH₂—, —(CH₂)₃—, —(CH₂)₄—, and —(CH₂)₅—; and each of R² and R³ independently is (C₁-C₂)alkyl. In some such embodiments X is N cation; Z is —CO₂ anion; R¹ is any one of (C₁₂)alkyl, (C₁₃)alkyl, (C₁₄)alkyl, (C₁₅)alkyl, (C₁₆)alkyl, (C₁₇)alkyl, (C₁₈)alkyl, (C₁₉)alkyl, (C₂₀)alkyl, (C₂₁)alkyl, and (C₂₂)alkyl; Q¹ is —CH₂— or —CH₂CH₂—; and each of R² and R³ independently is methyl.

In some embodiments the dispersion desensitizer is the compound of formula (I) wherein: X is N cation; Z is —CO₂ anion; R¹ is R⁴—C(O)N(H)-Q²-; Q² is (C₂-C₆)alkylene; Q¹ is (C₁-C₅)alkylene; and each of R² and R³ independently is (C₁-C₁₀)alkyl. In some such embodiments X is N cation; Z is —CO₂ anion; R⁴ is (C₁₀-C₂₂)alkyl; Q² is (C₃)alkylene; Q¹ is any one of —CH₂—, —CH₂CH₂—, —(CH₂)₃—, —(CH₂)₄—, and —(CH₂)₅—; and each of R² and R³ independently is (C₁-C₂)alkyl. In some such embodiments X is N cation; Z is —CO₂ anion; R⁴ is any one of (C₁₀)alkyl, (C₁₁)alkyl, (C₁₂)alkyl, (C₁₃)alkyl, (C₁₄)alkyl, (C₁₆)alkyl, (C₁₈)alkyl, (C₁₉)alkyl, (C₂₀)alkyl, (C₂₁)alkyl, and (C₂₂)alkyl; Q² is —(CH₂)₃—; Q¹ is —CH₂— or —CH₂CH₂—; and each of R² and R³ independently is methyl.

In some embodiments the dispersion desensitizer is the compound of formula (I) wherein: X is N cation; Z is —SO₃ anion; R¹ is R⁴—C(O)N(H)-Q²-; Q² is (C₂-C₆)alkylene; Q¹ is (C₁-C₅)alkylene; and each of R² and R³ independently is (C₁-C₁₀)alkyl. In some such embodiments X is N cation; Z is —SO₃ anion; R⁴ is (C₁₀-C₂₂)alkyl; Q² is (C₃)alkylene; Q¹ is any one of —CH₂—, —CH₂CH₂—, —(CH₂)₃—, —(CH₂)₄—, and —(CH₂)₅—; and each of R² and R³ independently is (C₁-C₂)alkyl. In some such embodiments X is N cation; Z is —SO₃ anion; R⁴ is any one of (C₁₀)alkyl, (C₁₁)alkyl, (C₁₂)alkyl, (C₁₃)alkyl, (C₁₄)alkyl, (C₁₆)alkyl, (C₁₈)alkyl, (C₁₉)alkyl, (C₂₀)alkyl, (C₂₁)alkyl, and (C₂₂)alkyl; Q² is —(CH₂)₃—; Q¹ is —CH₂— or —CH₂CH₂—; and each of R² and R³ independently is methyl.

In some embodiments the dispersion desensitizer is the compound of formula (I) selected from the group consisting of:
N-(3-erucylamino)propyl-N,N-dimethylglycine;
N-(3-coco-derived acylamino)propyl-N,N-dimethylglycine;
N-(3-laurylamino)propyl-N,N-dimethylglycine;
N-(3-myristylamino)propyl-N,N-dimethylglycine;
N-(3-cetylamino)propyl-N,N-dimethylglycine; and
N-(3-cocoamidopropyl)-N,N-dimethyl-N-(2-hydroxy-3-sulfopropyl)ammonium betaine.

The N-(3-erucylamiodo)propyl-N,N-dimethylglycine, N-(3-coco-derived acylamino)propyl-N,N-dimethylglycine, and N-(3-cocoamidopropyl)-N,N-dimethyl-N-(2-hydroxy-3-sulfopropyl)ammonium betaine respectively have the structures of formulas (i), (Ia), and (Ib):

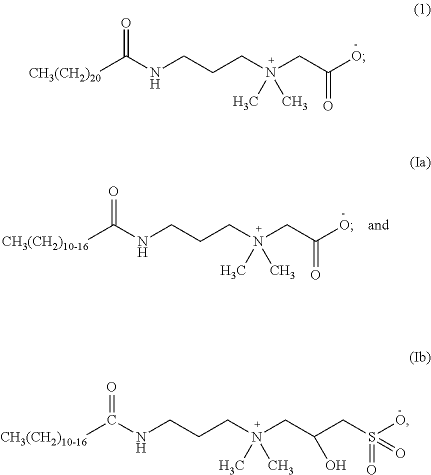

and preferably the CH₃CH₁₀—C(O)-containing member thereof.

The N-(3-laurylamino)propyl-N,N-dimethylglycine; N-(3-myristylamino)propyl-N,N-dimethylglycine; and N-(3-cetylamino)propyl-N,N-dimethylglycine; respectively have the structures of formula (2) to (4):

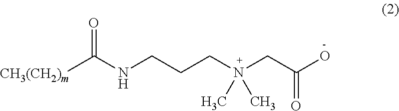

m is 10; (3) m is 12; and (4) m is 14.

In some embodiments the dispersion desensitizer is the compound of formula (I) selected from the group consisting of: N-dodecyl-N,N-dimethylglycine; N-tetradecyl-N,N-dimethylglycine; and N-hexadecyl-N,N-dimethylglycine, which respectively have the structures of formulas (5) to (7):

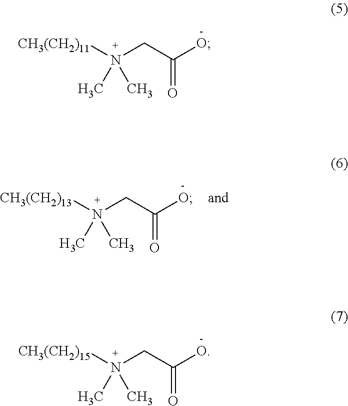

In some embodiments the dispersing desensitizer is as defined in any one of the Examples of the Present Invention described later.

Certain compounds of formula (I) that are employed in the preparation of the invention dispersions can be obtained from commercial suppliers (e.g., Sigma-Aldrich Company, St. Louis, Mo., USA and Rhodia Group, Paris, France). Preferably for cost reasons, the dispersion desensitizer is obtained from a commercial source. If necessary, the compounds of formula (I) can be readily synthesized by conventional means. For example, when R¹ is (C₆-C₃₀)alkyl or (C₆-C₃₀)alkenyl, the compound of formula (I) can be prepared by contacting a conjugate base of an amino acid of formula (a):

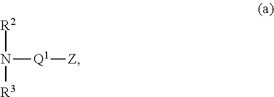

wherein R², R³, Q¹, and Z are as defined for formula (I), with a compound of formula (b1) or (b2): (C₆-C₃₀)alkyl-LG (b1) or (C₆-C₃₀)alkenyl-LG (b2), wherein LG is a leaving group such as, for example, a halide, tosylate, trifluoromethanesulfonate, or trifluoroacetate in a polar solvent such as, for example, acetone, acetonitrile, tetrahydrofuran, or ethanol at a temperature of from ambient temperature to 200° C. to give the compound of formula (I) wherein R¹ is (C₆-C₃₀)alkyl or (C₆-C₃₀)alkenyl. The compounds of formula (I) wherein X is P cation instead of N cation can be prepared in a similar manner. When R¹ is R⁴—C(O)N(H)-Q²-, the compound of formula (I) can be prepared by contacting a compound of formula (c1) or (c2): R⁴—C(O)-halide (c1) or R⁴—C(O)—OH (c2) with a compound of formula (d): NH₂— Q²-LG (d), wherein Q² is as defined for formula (I) and LG is a leaving group as defined previously, under coupling conditions, optionally with a coupling agent such as dicyclohexylcarbodiimide for the R⁴—C(O)—OH, in an aprotic solvent such as acetonitrile or acetone or tetrahydrofuran at a temperature from −70° C. to 100° C. to give an intermediate of formula (e): R⁴—C(O)—NH— Q²-LG (e). The intermediate of formula (e) can then be contacted with the conjugate base of an amino acid of formula (a), which is as defined previously, under contacting conditions described previously for such a coupling, to give the compound of formula (I) wherein R¹ is R⁴—C(O)N(H)-Q²-.

Syntheses of some of the compounds of formula (I) may utilize starting materials, intermediates, or reaction products that contain more than one reactive functional group. During chemical reactions, a reactive functional group may be protected from unwanted side reactions by a protecting group that renders the reactive functional group substantially inert to the reaction conditions employed. A protecting group is selectively introduced onto a starting material or intermediate prior to carrying out the reaction step for which the protecting group is needed. Once the protecting group is no longer needed, the protecting group can be removed. It is well within the ordinary skill in the art to introduce protecting groups during a synthesis and then later remove them. Procedures for introducing and removing protecting groups are known, for example, in Protective Groups in Organic Synthesis, 3rd ed., Greene T. W. and Wuts P. G., Wiley-Interscience, New York, 1999. The following moieties are examples of protecting groups that may be utilized to protect amino, hydroxy), or other reactive functional groups: carboxylic acyl groups such as, for example, formyl, acetyl, and trifluoroacetyl; alkoxycarbonyl groups such as, for example, ethoxycarbonyl, tert-butoxycarbonyl (BOC), β,β,β-trichloroethoxycarbonyl (TCEC), and β-iodoethoxycarbonyl; aralkyloxycarbonyl groups such as, for example, benzyloxycarbonyl (CBZ), para-methoxybenzyloxycarbonyl, and 9-fiuorenylmethyloxycarbonyl (FMOC); trialkylsilyl groups such as, for example, trimethylsilyl (TMS) and tert-butyldimethylsilyl (TBDMS); and other groups such as, for example, triphenylmethyl (trityl), tetrahydropyranyl, vinyloxycarbonyl, ortho-nitrophenylsulfenyl, diphenylphosphinyl, para-toluenesulfonyl (Ts), mesyl, trifluoromethanesulfonyl, methoxymethyl (MOM), and benzyl. Examples of procedures for removing protecting groups include hydrogenolysis of CBZ groups using, for example, hydrogen gas at about 3.4 atmospheres in the presence of a hydrogenation catalyst such as 10% palladium on carbon, acidolysis of BOC or MOM groups using, for example, hydrogen chloride in dichloromethane or trifluoroacetic acid (TFA) in dichloromethane, reaction of silyl groups with fluoride ions, and reductive cleavage of TCEC groups with zinc metal.

In some embodiments the invention dispersion is characterized by a particular combination of any two of the aforementioned ingredients (a) to (d). In some embodiments the invention dispersion consists essentially of ingredients (a) to (d).

In some embodiments the invention dispersion further comprises the at least one additional dispersion ingredient that is not ingredients (a) to (d). The at least one additional dispersion ingredient can be a dispersing additive or a non-dispersing (ancillary) additive. The at least one additional additive is present in an amount that does not negative use of the invention dispersion as described herein. Such amount preferably is from >0 wt % to 10 wt % of total weight of the invention dispersion.

In some embodiments the at least one additional dispersion ingredient is the dispersing additive. The dispersing additive is not a source of the extra metal cation content. Preferably, the dispersing additives are useful for further improving the dispersion stability of certain embodiments of the invention dispersion. In some embodiments the dispersing additives also have additional functions. In some embodiments the at least one additional dispersing agent is a the dispersing additive, which is another dispersing carboxylate salt independently as described previously for ingredient (c). In other embodiments the at least one additional dispersing agent is the dispersing additive is an organic thickener (e.g., polyvinyl alcohol, polyvinyl pyrrolidone, polyvinyl methyl ether, polyethylene oxide, polyacrylamide, polyacrylic acid, carboxy methyl cellulose, methyl cellulose, and hydroxyethyl cellulose); inorganic thickener (e.g., silicon dioxide, active clay, and bentonite); nonionic dispersing agent; anionic dispersing agent (e.g., sulfonate anion); or water-soluble polyvalent metal salt. In still other embodiments the dispersing additive comprises a polar group-containing polymer. In some embodiments the polar group-containing polymer comprises an alkyl ether carboxylate, petroleum sulfonate, sulfonated polyoxyethylenated alcohol, sulfated or phosphated polyoxyethylenated alcohol, polymeric ethylene oxide/propylene oxide/ethylene oxide dispersing agent, primary and secondary alcohol ethoxylate, alkyl glycoside, or alkyl glyceride. In other embodiments the polar group-containing polymer comprises an ethylene-carboxylic acid copolymer such as, for example, an ethylene acrylic acid copolymer (i.e., a poly(ethylene-co-acrylic acid) or ethylene methacrylic acid copolymer (i.e., a poly(ethylene-co-methacrylic acid)). Preferably, the polar group-containing polymer comprises at least one of the ethylene-acrylic acid copolymer and ethylene-methacrylic acid copolymer. One example of the ethylene-acrylic acid copolymer is the PRIMACOR® 5980I copolymer.

In some embodiments the at least one additional dispersing agent is the non-dispersing additive. The non-dispersing (ancillary) additive is a potential source of the extra metal cation. Examples of the non-dispersing additives are water-soluble amino resins (e.g., water-soluble melamine resin and water-soluble benzoguanamine resin); water-soluble epoxy resins; an anti-rust agent; anti-mold agent; ultraviolet (UV) light absorber; thermal stabilizer; foaming agent (i.e., gas dispersion agent); antifoaming agent; pigments (e.g., titanium white, red iron oxide, phthalocyanine, carbon black, and permanent yellow); and fillers (e.g., calcium carbonate, magnesium carbonate, barium carbonate, talc, aluminum hydroxide, calcium sulfate, kaolin, mica, asbestos, mica, and calcium silicate). In some embodiments the non-dispersing additive contains a metal cation. In other embodiments the non-dispersing additive lacks a metal cation.

In some embodiments the invention dispersion further comprises the additional dispersion ingredient, and the additional dispersion ingredient comprises the extra metal cation. The extra metal cation can be a desired ingredient of the invention dispersion or a contaminant therein. The contaminant could arise, for example, by using a so-called hard water as ingredient (a), wherein the hard water contains levels of the extra metal cations that would otherwise cause agglomeration of the APTP particles if not for the agglomeration-inhibiting effect of ingredient (d).

In some embodiments the invention dispersion further comprises the additional dispersion ingredient, and the additional dispersion ingredient and the at least one additional formulation ingredient are the same. In other embodiments the additional dispersion ingredient and the at least one additional formulation ingredient are different.

In some embodiments the invention dispersion further comprises the additional dispersion ingredient, and the additional dispersion ingredient comprises at least one solvent. The solvent-containing invention dispersion embodiments can be useful, for example, in applications where it is desirable to wet the invention dispersion on an organic polymer substrate to be coated therewith. When present, the solvent preferably is from >0 wt % to 10 wt % of total weight of the invention dispersion. In any event, any solvent is present in an amount that does not negative use of the invention dispersion as described herein. In such embodiments, preferably the solvent is a (C₄-C₁₂)hydrocarbon. In some embodiments the (C₄-C₁₂)hydrocarbon is a (C₄-C₁₂)alkane (linear or branched), (C₄-C₁₂)alkene (linear or branched), (C₄-C₁₂)cycloalkane (monocyclic or (C₇-C₁₂)bicyclic), (C₄-C₁₂)cycloalkene, or (C₆-C₁₂)arene (e.g., benzene or naphthalene). Preferably, the invention dispersion lacks the at least one solvent.

The invention method can be used to prepare any of the foregoing embodiments of the invention dispersion. In some embodiments the invention method further comprises a preliminary step of preparing the aqueous APTP predispersion. Preferably, the preliminary step comprises preparing the aqueous APTP predispersion by melting an APTP resin (e.g., pellets, flakes, or granules) in an aqueous mixture comprising water (ingredient (a)) and the dispersing carboxylate salt (ingredient (c)), and allowing the resulting melted APTP to cool under dispersing conditions so as to form the aqueous APTP predispersion. While any suitable method can be used to prepare the aqueous APTP predispersion, one convenient method is a melt-kneading process.

Any melt kneading means known in the art may be used to prepare the aqueous APTP predispersion. The melt kneading can be conducted under conditions that are typically used for melt kneading a thermoplastic resin like the polyolefin. An example of a preferred melt-kneading process is melt-kneading the above-mentioned ingredients according to the melt-kneading process of U.S. Pat. No. 5,756,659 or U.S. Pat. No. 6,455,636.

Typically, the melt-kneading process for preparing the aqueous APTP predispersion generally comprises adding a basic substance and source of ingredient (c) (e.g., conjugate acid or alkyl ester of ingredient (c)) to a melt of the APTP resin comprising the aforementioned APTP. Preferably, the APTP resin is supplied in a form of pellets, powder, granules, or flakes. Preferably, the dispersing carboxylate salt (ingredient (c)) is supplied as is, in neat or aqueous solution form, or as its conjugate acid (i.e., dispersing carboxylic acid), which becomes neutralized in the process, or as a penultimate ester thereof (e.g., (C₁-C₄)alkyl dispersing carboxylic acid), which becomes saponified in the process. In some embodiments the basic substance is a neat material (e.g., NaOH pellets), or an aqueous solution, dispersion or slurry thereof. Examples of the basic substance that can be used for the neutralization of the conjugate carboxylic acid or the saponification of the penultimate ester thereof in the melt kneading process include carbonates, monohydrogen carbonates (i.e., bicarbonates), hydrides, hydroxides, and oxides of Group 1 and 2 metal cations; inorganic amines; organic amines; and ammonium hydroxides. In some embodiments the basic substance is a hydroxide of Group 1 metal cation or a hydroxide of a Group 2 metal cation. In some embodiments, the basic substance is selected from potassium hydroxide, sodium hydroxide, and combinations thereof.

In some embodiments the melt-kneading process for preparing the aqueous APTP predispersion employs a kneader, BANBURY mixer, single-screw extruder, or a multi-screw extruder. A preferred melt-kneading machine is, for example, a multi screw extruder having two or more screws, to which a kneading block can be added at any position of the screws. In some embodiments the mixer comprises a screw conveyor/mixer (e.g., a horizontal twin screw conveyor/mixer) such as a Sirator DU-trough conveyor screw, available from Segler-Förderanlagen Maschinenfabrik GmbH, Berge, Germany. In some embodiments the extruder has a flow direction for flowing a material to be kneaded that goes from an upstream location to a downstream location and comprises first, second, third, and fourth material-supplying inlets in an order from an upstream-most location to a downstream most location along the flow direction of the material to be kneaded. The material to be melt-kneaded comprises ingredients (a), (c), and the APTP as ingredient (b). The material to be melt-kneaded preferably lacks ingredient (d), which preferably is added later to the aqueous APTP predispersion comprising ingredients (a) to (c). Further, in some embodiments the extruder further comprises a vacuum vent, which can be located at an optional downstream position of the extruder. In some embodiments the material to be melt-kneaded, before being melt-kneaded, is first diluted to contain from about 1 wt % to about 3 wt % of water, and then subsequently further diluted to comprise greater than 25 wt % of water. In some embodiments the further dilution provides a material to be melt-kneaded comprising the APTP, ingredient (c), and at least about 30 percent by weight of water. In some embodiments where the aqueous APTP predispersion obtained by the melt kneading process is supplemented by mixing it with an aqueous dispersion of an ethylene-vinyl compound copolymer or a further dispersing agent. Preferably, the ingredient (b) comprises polyolefin particles and the aqueous APTP predispersion comprises an aqueous polyolefin predispersion.

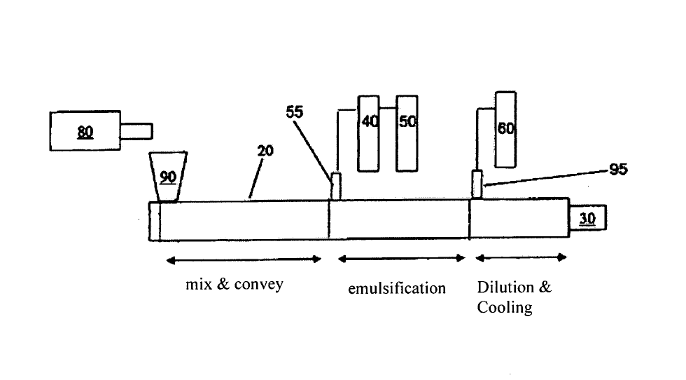

FIG. 1 schematically illustrates a melt extrusion apparatus useful in embodiments of the invention method. An extruder 20, in certain embodiments a twin-screw extruder, is coupled to a back pressure regulator/melt pump or gear pump, 30. Embodiments also provide a basic substance reservoir 40 (e.g., for holding the basic substance) and an initial water reservoir 50, each of which includes a pump (not shown). Desired amounts of the basic substance (e.g., aqueous NaOH) and initial water (e.g., deionized water) are provided from the basic substance reservoir 40 and the initial water reservoir 50, respectively. Any suitable pumps (not shown) can be used to pump the basic substance and water, but in some embodiments a pump (not shown) that provides a flow of about 150 milliliters per minute (mL/min) at a pressure of 240 bar (24,000 kilopascals (kPa)) can be used to provide the base and the initial water into the extruder 20. In other embodiments a liquid injection pump (not shown) provides a flow of 300 mL/min at 200 bar (20,000 kPa) or 600 mL/min at 133 bar (13,300 kPa). In some embodiments the basic substance and initial water are preheated in a preheater (not shown) before being pumped into the extruder 20.

The basic substance can be added to the APTP melt at any point of the melt-kneading process. Preferably, the basic substance is added from base reservoir 40 into the extruder 20 as described previously. Typically the basic substance is added as an aqueous solution thereof, but in some embodiments it is added in another convenient form such as pellets or granules. In some embodiments the basic substance and water are added through separate inlets (e.g., inlet 55 and another inlet (not shown) of the extruder 20. The APTP resin (for forming ingredient (b)) is fed from the feeder 80 to an inlet 90 of the extruder 20. The APTP resin is melted or compounded in extruder 20. In some embodiments the dispersing carboxylate salt (ingredient (c)), or its conjugate acid (i.e., dispersing carboxylic acid) or penultimate ester thereof (e.g., (C₁-C₄)alkyl dispersing carboxylic acid, is added to the APTP resin in the extruder 20 through an opening (e.g., inlet 90) in the extruder 20 along with the APTP resin. In other embodiments the dispersing carboxylate salt (ingredient (c)), or its conjugate acid (i.e., dispersing carboxylic acid) or penultimate ester thereof (e.g., (C₁-C₄)alkyl dispersing carboxylic acid, is provided via a separate opening (not shown) into the extruder 20. The APTP resin melt is then delivered from the labeled “mix & convey” zone of the extruder 20 to the zone of the extruder 20 labeled “emulsification.” In the emulsification zone the initial amount of base and water is added from the reservoirs 40 and 50, respectively, into the extruder 20 through inlet 55 thereof, and an emulsified mixture, or a saponified and emulsified mixture as the case may be with the penultimate ester, is produced. In some embodiments the dispersing carboxylate salt (ingredient (c)), or its conjugate acid (i.e., dispersing carboxylic acid) or penultimate ester thereof (e.g., (C₁-C₄)alkyl dispersing carboxylic acid, can also be added additionally or exclusively to the water. In some embodiments the emulsified mixture, or the saponified and emulsified mixture, is further diluted with additional water, which is added into the extruder 20 via inlet 95 from reservoir 60 in the labeled “Dilution & Cooling” zone of the extruder 20. In any event, the aqueous APTP predispersion is produced in the Dilution & Cooling zone of the extruder 20. In the Dilution & Cooling zone, the melted and dispersed APTP solidifies, thereby forming the APTP particles widely dispersed in the water with aid of ingredient (c), which has been added directly or formed in situ. In some embodiments the resulting aqueous APTP predispersion is diluted to at least 30 wt % water in the Dilution & Cooling zone to give a diluted aqueous APTP predispersion. The diluted aqueous APTP predispersion can be diluted any number of times in the Dilution & Cooling zone until a desired dilution level is achieved. The diluted aqueous APTP predispersion has a pH of at least pH 9.0 and an extra metal cation content below an agglomeration-promoting concentration of metal ions.

In other embodiments, the aqueous APTP predispersion is not formed in extruder 20, but is formed downstream thereof. That is, in such other embodiments the extruder discharges an APTP melt or APTP/ingredient (c) melt, and the water is not added into the extruder 20, but rather the water is added to the APTP melt or APTP/ingredient (c) melt after the APTP melt or APTP/ingredient (c) melt has been discharged from the extruder 20. In this manner, steam pressure build-up in the extruder 20 is eliminated.

Once the aqueous APTP predispersion (containing ingredients (a) to (c), but not ingredient (d)) is formed, it is preferably converted to the invention dispersion according to the invention method. An example of such a method has been described previously herein. In another example, the aqueous APTP predispersion can be contacted with the agglomeration-inhibiting effective amount of the dispersion desensitizer (ingredient (d)) and later, if necessary, a means for lowering pH, increasing extra metal ion content, or a combination of such means, the contacting being done in such a way so as to form the invention dispersion. Alternatively, the contacting forms a penultimate dispersion comprising ingredients (a) to (d) and having a pH of at least pH 9.0, having less than the agglomeration-promoting concentration of extra metal ion, or, for whatever reason, otherwise lacking agglomerates of the APTP particles (e.g., due to slow kinetics of agglomeration). Thereafter, the penultimate dispersion can be treated with a pH lowering or extra metal cation increasing reagent, or a combination thereof so as to lower pH of the penultimate dispersion below 9.0, increase extra metal cation content of the penultimate dispersion, or a combination thereof, so as to prepare the invention dispersion. In any event, the contacting step can be performed in the Dilution & Cooling zone of the extruder 20 or downstream thereof, including in a separate storage or preparation vessel (e.g., for preparing the formulation mixture), wherein the separate vessel is fitted with a means for stirring contents thereof. The contacting can be performed at a much later time than the preparation of the aqueous APTP predispersion provided that pH of the aqueous APTP predispersion or penultimate dispersion is maintained at about 9.0 or higher and extra metal cation content of the aqueous APTP predispersion is maintained below the agglomeration-promoting concentration until the contacting step has been effective for preparing the invention dispersion. Preferably, the agglomeration-inhibiting effective amount of the dispersion desensitizer (ingredient (d)) is contacted with the aqueous APTP predispersion with vigorous mixing so as to prepare the invention dispersion, which is a substantially homogeneous mixture. The term “homogeneous” as applied to a mixture means uniformly mixed. In any event, pH and metal cation content of the invention dispersion can be adjusted as desired by any suitable means such as those means described herein (e.g., adding neat or solutions of an acid or extra metal cation containing material). In some embodiments the invention method further comprises an aforementioned step or steps of the melt-kneading process.

Composition of the invention dispersion and its preparation are advantageously flexible. For example, weight percents of the ingredients, volume percent solids content, pH, extra metal cation content, and viscosity can be varied within the aforementioned ranges to optimize them for particular circumstances. Examples of particular circumstances are particular structure of the dispersion desensitizer or its amount or desensitizing effectiveness (e.g., typically better dispersion desensitization is observed with increasing size or length of R¹); particular structure of the dispersing carboxylate salt or its amount or dispersion-forming effectiveness; a particular amount of one of the ingredients used; ease of preparation of the invention dispersion; preparation conditions (e.g., temperature); presence or absence of any additional ingredient(s) (e.g., a polar group-containing polymer as an additional dispersion-forming agent in the invention dispersion or the at least one additional formulation ingredient in the formulation product); and anticipated end-use application. For convenience, the invention dispersion can be prepared using particular APTP and particle size, a particular dispersing carboxylate salt, and a particular dispersion desensitizer; and concentrations of the ingredients (b) to (d) can be set to the bottom of their wt % concentration ranges. Thereafter, within the skill of a person of ordinary skill in the APTP dispersion art, the wt % concentrations of the ingredients, with or without increasing the vol % solids content of the invention dispersion, can be gradually increased until a desired effect of the invention dispersion under the circumstances is achieved. Alternatively, an invention dispersion having a desired set of wt % ingredients concentrations and, if desired, vol % solids content, can be prepared by using measured amounts of the ingredients and preparing the invention dispersion directly according to the invention method. In any event, if desired, pH of the resulting invention dispersions can be gradually lowered to a desired pH value; their extra metal ions content can be gradually increased; or both. The pH of the invention dispersions can be lowered by, for example, adding an inorganic protic acid such as, for example, 0.1 molar hydrochloric acid. The inorganic protic acid addition can be periodic (e.g., dropwise) while monitoring the invention dispersion with a pH meter or all at once, i.e., by adding a predetermined amount of inorganic protic acid that is calculated to give the desired pH can be added directly. The extra metal cation content of the invention dispersions can be increased by adding an inorganic or organic metal salt such as, for example, calcium chloride or zinc ethoxide. Alternatively, the extra metal cation content can be provided by preparing or diluting the invention dispersion with water contaminated or containing the extra metal cation (e.g., the so-called hard water), wherein the water contains the agglomeration-promoting effective amount of extra metal cations. The added metal salt can be a solid or liquid (e.g., an aqueous metal salt solution). The metal salt addition can be periodic (e.g., dropwise addition of a 0.1 molar aqueous calcium chloride solution) or all at once. The pH of the aqueous metal salt solution can be adjusted to a desired pH value if desired. In some embodiments pH of the invention dispersion is lowered and extra metal cation content is increased simultaneously, for example, by adding the aqueous metal salt solution wherein its pH is adjusted so as to lower pH of the invention dispersion. The lowering of pH or increasing of extra metal cation content can be continued until the desired pH, metal cation content, or both for the invention dispersion under the circumstances is achieved.

One embodiment of the invention dispersion can be used to prepare another and different embodiment of the invention dispersion (e.g., by varying pH, metal ion content, or adding additional dispersion ingredients as described previously).

As mentioned previously, the invention dispersions can be used to prepare the invention formulation product. In some embodiments the invention is a method of preparing the invention formulation product, the method comprising contacting the invention dispersion with the at least one additional formulation ingredient in such a way so as to prepare the invention formulation mixture.

In some embodiments of the invention formulation product that is the invention hair or personal care product to be applied to the skin, the invention dispersion is employed therein or functions as an emollient. In such embodiments, preferably at least one of the at least one additional formulation ingredient comprises an anti-inflammatory agent, antipruritic agent, colorant, diluent, disinfectant (e.g., ethanol), additional emollient (non-invention), or scent.

In some embodiments of the invention formulation product that is the invention shampoo, the invention dispersion is employed therein or functions as an emollient. In such embodiments, preferably at least one of the at least one additional formulation ingredient of the invention formulation product comprises an antipruritic agent, cleaning ingredient (e.g., anionic surfactant), colorant, diluent, disinfectant (e.g., ethanol), emollient (non-invention), or scent.

In some embodiments of the invention formulation product that is the invention leather plasticizer, the invention dispersion is employed therein or functions as a softening or conditioning ingredient. In such embodiments, preferably at least one of the at least one additional formulation ingredient of the invention formulation product comprises a dye or a softening agent that is lanolin, beeswax, emu oil, tea tree oil, pinegum, eucalyptus, dubbin, vegetable oil, or animal fat.

In some embodiments of the invention formulation product that is the invention adhesive material, the invention dispersion is employed therein or functions as a release additive. In such embodiments, preferably at least one of the at least one additional formulation ingredient of the invention formulation product comprises an acidic organic polymer such as a polyacrylic acid (PAA).

Preferably, the manufactured product is prepared from the invention dispersion as described previously.

Illustrative examples of the present invention are provided later where the examples employ certain methods and materials, which include certain preparations. The methods and materials and preparations are described in the following section.

### Materials, Methods, and Preparations

Behenic acid is purchased from Parchem Fine & Specialty Chemical Company, New Rochelle, N.Y., USA.

N-(3-erucylamino)propyl-N,N-dimethylglycine is purchased from Rhodia Group, Paris, France.

N-(3-coco-derived acylamino)propyl-N,N-dimethylglycine is purchased from Rhodia Group

N-(3-laurylamino)propyl-N,N-dimethylglycine is purchased from Rhodia Group

N-dodecyl-N,N-dimethylglycine is purchased from Rhodia Group

N-tetradecyl-N,N-dimethylglycine is purchased from Rhodia Group

N-hexadecyl-N,N-dimethylglycine is purchased from Rhodia Group

ENGAGE® 8200 ethylene/1-octene copolymer is purchased from The Dow Chemical Company and has the properties shown in Table 1.

TABLE 1
properties of ENGAGE ® 8200

| Property | Test Method | Value |
|---|---|---|
| Physical properties: | | |
| Melt Index (190° C./2.16 kg, in | ASTM D 1238 | 5.0 dg/min |
| decigrams per minute (dg/min)) | | |
| Density in gram per cubic centimeter | ASTM D 792 | 0.870 g/cm3 |
| (g/cm3) | | |
| Mooney Viscosity (mooney (ML) | ASTM D 1646 | 8 ML |
| 1 + 4 at 121° C.) | | |
| Molded (compression) properties: | | |
| Ultimate Tensile Strength (508 millimeters | ASTM D 638 | 5.7 MPa |
| per minute (mm/min); megapascals | | |
| (MPa)) | | |
| Ultimate Tensile Elongation | ASTM D 638 | 1140% |
| (508 mm/min; percent (%)) | | |
| 100% Modulus (508 mm/min; MPa) | ASTM D 638 | 2.3 MPa |
| Hardness | | |
| Shore A (1 second) | | 66 |
| Shore D (1 second) | ASTM D 2240 | 17 |
| Flexural Modulus (MPa) | | |
| 1% Secant | ASTM D 790 | 10.9 |
| 2% Secant | | 10.8 |
| Tear Strength (Type C; kiloNewtons | ASTM D 624 | 37.1 |
| per meter (kN/m)) | | |
| Thermal properties: | | |
| Vicat Softening Point (° C.) | ASTM D 1525 | 37° C. |
| Differential Scanning Calorimetry (DSC) | DSC method | 59° C. |
| Melting Point (10° C./min rate; ° C.) | below | |
| Glass transition temperature (Tg; ° C.) | DSC Method | −53° C. |
| | below | |
| Peak Crystallization temperature (Tc; ° C.) | DSC method | 44° C. |
| | below | |

### Differential Scanning Calorimetry of Polyolefin

DSC instrument model Q1000 DSC from TA Instruments, Inc., equipped with an RCS cooling accessory and an autosampler, and calibrated using indium and deionized water is calibrated as follows. First, a baseline is obtained by running a DSC from −90° C. without any sample in the aluminum DSC pan. Then 7 milligrams of a fresh indium sample is analyzed by heating the sample to 180° C., cooling the sample to 140° C. at a cooling rate of 10° C./min, followed by keeping the sample isothermally at 140° C. for 1 minute, followed by heating the sample from 140° C. to 180° C. at a heating rate of 10° C./min. The heat of fusion and the onset of melting of the indium sample are determined and checked to be within 0.5° C. from 156.6° C. for the onset of melting and within 0.5 J/g from 28.71 J/g for the of fusion. Then deionized water is analyzed by cooling a small drop of fresh sample in the DSC pan from 25° C. to −30° C. at a cooling rate of 10° C./min. The sample is kept isothermally at −30° C. for 2 minutes and heated to 30° C. at a heating rate of 10° C./min. The onset of melting is determined and checked to be within 0.5° C. from 0° C.

DSC analysis: A nitrogen purge gas flow of 50 milliliters per minute (mL/min) is used. The sample is pressed into a thin film and melted in the press at about 175° C., and then air-cooled to room temperature (25° C.). 3 mg to 10 mg of polyolefin is then cut into a 6 mm diameter disk, accurately weighed (about 50 mg), placed in a light aluminum pan, and pan is crimped shut. Thermal behavior of the sample is investigated with the following temperature profile. The sample is rapidly heated to 180° C., and held isothermal for 3 minutes in order to remove any previous thermal history. The sample is then cooled to −40° C. at 10° C./min cooling rate, and held at −40° C. for 3 minutes. The sample is then heated to 150° C. at 10° C./min heating rate. The cooling and second heating curves are recorded. The DSC melting peak is measured as the maximum in heat flow rate (W/g) with respect to the linear baseline drawn between −30° C. and end of melting. The heat of fusion is measured as the area under the melting curve between −30° C. and the end of melting using a linear baseline. Record Tₘₑ (temperature at which melting ends) and Tₘₐₓ (peak melting temperature).

Glass transition temperature, melting point, peak crystallization temperature, and percent crystallinity of polyolefin: DSC is determined using a model Q1000 DSC from TA Instruments, Inc, which is calibrated using indium and deionized water. After heating the sample rapidly to 230° C., and holding for 3 minutes, the cooling curve is obtained by cooling at 10° C./min to −40° C. After holding at −40° C. for 3 minutes, the DSC melting endotherm is recorded while heating at 10° C./min. The glass transition temperature (Tg), melting point (Tm), peak crystallization temperature (Tc), and percent crystallinity are determined using the standard TA Instruments DSC software.

Molecular weight distribution of the polymers is determined using gel permeation chromatography (GPC) on a Polymer Laboratories PL-GPC-220 high temperature chromatographic unit equipped with four linear mixed bed columns (Polymer Laboratories (20-micron particle size)). The oven temperature is at 160° C. with the autosampler hot zone at 160° C. and the warm zone at 145° C. The solvent is 1,2,4-trichlorobenzene containing 200 parts per million (ppm) 2,6-di-t-butyl-4-methylphenol. The flow rate is 1.0 milliliter/minute and the injection size is 100 microliters. About 0.2 percent by weight solutions of the samples are prepared for injection by dissolving the sample in nitrogen purged 1,2,4-trichlorobenzene containing 200 ppm 2,6-di-t-butyl-4-methylphenol for 2.5 hours at 160° C. with gentle mixing.

The molecular weight determination is deduced by using ten narrow molecular weight distribution polystyrene standards (from Polymer Laboratories, EasiCal PSI ranging from 580 g/mol to 7,500,000 g/mole) in conjunction with their elution volumes. The equivalent propylene-ethylene copolymer molecular weights are determined by using appropriate Mark-Houwink coefficients for polypropylene (as described by Th. G. Scholte, N. L. J. Meijerink, H. M. Schoffeleers, and A. M. G. Brands, Journal of Applied Polymer Science, 29, 3763-3782 (1984)) and polystyrene (as described by E. P. Otocka, R. J. Roe, N.Y. Hellman, P. M. Muglia, Macromolecules, 4, 507 (1971)) in the Mark-Houwink equation: {N}=KMa, where Kₚₚ=1.90E-04, aₚₚ=0.725 and Kₚₐ=1.26E-04, aₚₛ=0.702.

### Preparation 1

### Preparation of pH 11 Aqueous Predispersion of Ethylene/1-Octene Copolymer with Potassium Behenoate to Give Predispersion P1

Feed 10,000 parts ethylene/1-octene copolymer (ENGAGE® 8200) into a resin hopper of a polymer extruder (extruder model number ZSK 26 MEGAcompounder PLUS (McPLUS), manufacturer name Coperion Corp., Ramsey, N.J., USA) together with 300 parts (active weight) of dispersant (Behenic acid, a dispersant containing a 22 carbon chain fatty acid as active component), and melt-knead by a single extruder at about 160° C. to give a molten polymer/behenic acid blend (molten blend). Thereafter, into the barrel of a twin-screw extruder pump a solution of 32 parts potassium hydroxide dissolved in 398 parts deionized water into the molten blend under pressure and at a temperature of about 165° C. As the molten blend/aqueous KOH mixture passes down the barrel of the extruder, add deionized water until producing a predispersion having about 40 wt % to 60 wt % solids. Cool the predispersion to below 90° C. before extruding it from the extruder and then collecting it in a container to give Predispersion P 1.

Predispersion P1 has pH 11.41 and a 44.86 wt % solids content. The solids are 97 wt % ethylene/1-octene copolymer and 3 wt % potassium behenoate. The ethylene/1-octene copolymer has a polydispersity index of 0.431 and a particle size volume mean (i.e., average particle size based on volume according to PROCEDURE PSM) of 0.927 micron and a particle size range of from about 0.4 micron to 1.5 micron according to PROCEDURE PSM.

Unless otherwise noted herein, calculate wt % potassium behenoate based on weight of behenic acid used and total weight of the (pre)dispersion.

### Preparation 2

### Preparation of pH 11 Aqueous Predispersion of Ethylene/1-Octene Copolymer with Potassium Salt of UNICID™ 350 Acid to Give Predispersion P2 (i.e., 8101-PETROSTEP SB)

Prepare the predispersion using ethylene/1-octene copolymer (ENGAGE® 8200), UNICID™ 350 Acid (having a melting point of 92° C. by ASTM D-127; a penetration at 25° C. of 9 dmm by ASTM D-1321; a viscosity at 149° C. of 4 centipoise by ASTM D-3236; and an acid number of 120 milligrams KOH per gram sample by BWM 3.01 A), and potassium hydroxide in a manner similar to the procedure of Preparation 1 to give predispersion P2. Predispersion P2 (i.e., 8101-PETROSTEP SB; data are from ICD) has pH >9 and a 45 wt % solids content. The solids are 97 wt % ethylene/1-octene copolymer and 3 wt % potassium salt of UNICID™ 350 Acid. The ethylene/1-octene copolymer a particle size volume mean (i.e., average particle size based on volume) of 0.912 micron according to PROCEDURE PSM.

### Preparation 3

### Preparation of pH 11 Aqueous Predispersion of Ethylene/1-Octene Copolymer with Ethylene-Acrylic Acid Copolymer that is the PRIMACOR® 5980I Copolymer to Give Predispersion P3 (i.e., 8502)

Prepare the predispersion using ethylene/1-octene copolymer (ENGAGE® 8200) and ethylene-acrylic acid copolymer that is PRIMACOR® 5980I copolymer (contains 20 wt % of acrylic acid residuals) in a manner similar to the procedure of Preparation 1, except using the PRIMACOR® 5980I copolymer instead of the behenic acid, to give predispersion P3. Predispersion P3 (i.e., 8502; data are from ICD) has pH >9 and a 42 wt % solids content. The solids are 85 wt % ethylene/1-octene copolymer and 15 wt % ethylene-acrylic acid copolymer. Predispersion P3 contains 3 wt % of acrylic acid residuals (15 wt % times 0.20). The ethylene/1-octene copolymer a particle size volume mean of 1.0 micron according to PROCEDURE PSM.

### COMPARATIVE EXAMPLE(S)

### Non-Invention

Comparative Example(s) are provided herein as a contrast to certain embodiments of the present invention and are not meant to be construed as being either prior art or representative of non-invention examples.

### Comparative Example A1

Into two separate vials (a) and (b) add 97 parts by volume of deionized water and 3 parts by volume of the predispersion P1 of Preparation 1. Mix diluted dispersions in each vial thoroughly. Into vials (a) and (b) gradually add 0.1 molar hydrochloric acid so as to reduce pH of the diluted dispersion therein to pH 9.84 and pH 6.5, respectively. Observe that the diluted dispersion in vial (a) is intact and tolerates the lowering of its pH to pH 9.84, whereas the diluted dispersion in vial (b) does not tolerate the lowering of its pH to pH 6.5, but instead forms agglomerates, which float to the top of the water in vial (b).

### Comparative Example A2

Into separate vials repeat three times with predispersion P1, P2, or P3 the preparation of the diluted dispersion as in Comparative Example A1. With the diluted dispersion prepared from predispersion P1, gradually add 0.1 molar hydrochloric acid so as to reduce pH of the diluted dispersions from pH 11 gradually to about pH 3. With the diluted dispersion prepared from predispersion P2 or P3, gradually add 0.1 molar hydrochloric acid so as to reduce pH of the diluted dispersions from pH 11 gradually to about pH 8.3. Periodically sample the diluted dispersion during the gradual pH lowering, and measure viscosity of the sample according to PROCEDURE VM. Graphically plot pH value versus viscosity in centipoise (cP) for the experiment with predispersion P1 to observe a substantially constant viscosity of about 250 cP from pH 11.4 down to about pH 9.2, and then a sharp increase of viscosity of the diluted dispersion to about 4100 cP at about pH 8.5 and >15,000 cP at pH 8.0. Graphically plot pH value versus viscosity in centipoise (cP) for the experiment with predispersion P2 to observe a substantially constant viscosity of about 250 cP from pH 11.8 down to about pH 10.4, and then a sharp increase of viscosity of the diluted dispersion to about 72,000 cP at about pH 8.3. Graphically plot pH value versus viscosity in centipoise (cP) for the experiment with predispersion P3 to observe a substantially constant viscosity of about 250 cP from pH 11.8 down to about pH 8.5, and then a sharp increase of viscosity of the diluted dispersion to about 3,000 cP at about pH 8.3, and then to >5,000 cP at pH 8.2.

### Comparative Examples B1

Into a flask add 80 parts by volume of deionized water and 20 parts by volume of the predispersion P1 of Preparation 1. Mix the resulting diluted dispersion in vial thoroughly. Slowly add with mixing a 2 wt % calcium chloride solution in deionized water to the diluted dispersion until any phase separation occurs into an upper agglomerates phase and a lower liquid phase. Observe that severe agglomeration occurs after adding 0.17 mL of the 2 wt % calcium chloride solution.

Non-limiting examples of the present invention are described below that illustrate some specific embodiments and aforementioned advantages of the present invention that use for convenience polyolefin particles as examples of the APTP particles. Preferred embodiments of the present invention incorporate one limitation, and more preferably any two, limitations of the Examples, which limitations thereby serve as a basis for amending claims.

### EXAMPLE(S) OF THE PRESENT INVENTION

### Examples 1, 2a, 2b, and 3 to 8

### Preparation of a Desensitized Ethylene/1-Octene Copolymer Dispersions

Contact a known weight of the predispersion P1 of Preparation 1 (Examples 1, 2a, 2b, and 3 to 5); predispersion P2 (Example 6); or predispersion P3 (Examples 7 and 8) with a quantity of a dispersion desensitizer that is N-(3-erucylamiodo)propyl-N,N-dimethylglycine (C22ABET); N-(3-coco-derived acylamino)propyl-N,N-dimethylglycine (COABET) X 2; N-dodecyl-N,N-dimethylglycine (C12BET); N-tetradecyl-N,N-dimethylglycine (C14BET); N-hexadecyl-N,N-dimethylglycine (C16BET); N-(3-cocoamidopropyl)-N,N-dimethyl-N-(2-hydroxy-3-sulfopropyl)ammonium betaine (COSABET); or COABET X 2 so as to respectively prepare the desensitized ethylene/1-octene copolymer dispersions of Examples 1, 2a, 2b, and 3 to 8 having a wt % of their respective dispersion desensitizer based on total weight of the desensitized ethylene/1-octene copolymer dispersions as shown in Table 2.

TABLE 2
composition of the Example desensitized ethylene/1-octene
copolymer dispersions

| | | | Concentration | Concentration |
|---|---|---|---|---|
| | | | of dispersion | of dispersion |
| Exam- | Predispersion | | desensitizer − | desensitizer − |
| ple | Preparation | Dispersion | polyolefin | dispersion |
| Number | Number | desensitizer | (wt %)* | (wt %)** |
| 1 | P1 | C22ABET | 2.3 | 1 |
| 2a | P1 | COABET | 2.3 | 1 |
| 2b | P1 | COABET | 0.57 | 0.25 |
| 3 | P1 | C12BET | 2.3 | 1 |
| 4 | P1 | C14BET | 2.3 | 1 |
| 5 | P1 | C16BET | 2.3 | 1 |
| 6 | P2 | COSABET | 2.3 | 1 |
| 7 | P3 | COABET | 2.3 | 1 |
| 8 | P3 | COABET | 6.9 | 3 |

*Concentration of dispersion desensitizer − polyolefin (wt %) means weight of dispersion desensitizer divided by total of (weight of dispersion desensitizer + weight of polyolefin), expressed as a percent; and
**Concentration of dispersion desensitizer − dispersion (wt %) means weight of dispersion desensitizer divided by total of weight of dispersion, expressed as a percent.

### Examples A1 and A2a

### Respective pH Tolerance of the C22ABET-Desensitized Ethylene/1-Octene Copolymer Dispersion and the COABET-Desensitized Ethylene/1-Octene Copolymer Dispersion

Into three separate vials (a) to (c) add 97 parts by volume of deionized water and 3 parts by volume of the 1 wt % C22ABET-desensitized ethylene/1-octene copolymer dispersion of Example 1. Likewise into three other separate vials (d) to (f) add 97 parts by volume of deionized water and 3 parts by volume of the COABET-desensitized ethylene/1-octene copolymer dispersion of Example 2a. Mix diluted dispersions in each vial thoroughly. Into vials (a) and (d) gradually add with mixing 0.1 molar hydrochloric acid so as to reduce pH of the diluted dispersions therein to pH 9.27 and pH 9.96, respectively. Into vials (b) and (e) gradually add with mixing 0.1 molar hydrochloric acid so as to reduce pH of the diluted dispersions therein to pH 1.87 and pH 1.86, respectively. Into vials (c) and (f) gradually add 0.1 molar hydrochloric acid so as to reduce pH of the diluted dispersions therein to pH 1.4 and pH 1.39, respectively. Observe that each diluted dispersion in each of vials (a) to (f) is intact and tolerates the lowering of its pH to the above pH values.

### Examples A3, A4, A5, A6, A7, A8, A9, and A10

### Respective pH Tolerance of the C22ABET-, COABET-, C12BET-, C14BET-, C16BET-, COSABET-, and COABET-Desensitized Ethylene/1-Octene Copolymer Dispersions

Into two vials separately repeat the preparations of the diluted dispersions in vials (a) and (d) of Examples A1 and A2a to respectively give diluted C22ABET-desensitized ethylene/1-octene copolymer dispersion of Example A3 and diluted COABET-desensitized ethylene/1-octene copolymer dispersion of Example A4. Into six vials separately repeat six times the preparation of the diluted dispersion in vial (a) of Example A1 except use the C12BET-, C14BET-, C16BET-, COSABET-, or COABET-desensitized ethylene/1-octene copolymer dispersion of Examples 3 to 8, respectively, instead of the C22ABET-desensitized ethylene/1-octene copolymer dispersion of Example 1 to give the diluted C12BET-desensitized ethylene/1-octene copolymer dispersion of Example A5; the diluted C14BET-desensitized ethylene/1-octene copolymer dispersion of Example A6; the diluted C16BET-desensitized ethylene/1-octene copolymer dispersion of Example A7; the diluted COSABET-desensitized ethylene/1-octene copolymer dispersion of Example A8; and the diluted COABET-desensitized ethylene/1-octene copolymer dispersions of Examples A9 and A10. Gradually add with mixing 0.1 molar hydrochloric acid into the vials so as to reduce pH of the diluted dispersions from pH 11 gradually to about pH 1 (for Examples A3 and A4); from pH 11 gradually to pH 7.9 (for Example A5); from pH 11 gradually to pH 6.1 (for Example A6); from pH 11 gradually to pH 3.0 (for Example A7); from pH 11 gradually to pH 4.3 (for Example A8); from pH 11 gradually to pH 7.2 (Example A9); or from pH 11 gradually to pH 0.7 (Example A10). Periodically sample the diluted dispersion during the gradual pH lowering, and measure viscosity of the sample according to PROCEDURE VM. Graphically plot pH value versus viscosity in centipoise (cP). For the diluted C22ABET-desensitized ethylene/1-octene copolymer dispersion and COABET-desensitized ethylene/1-octene copolymer dispersion, observe viscosities of the pH lowered diluted dispersions. Results are shown below in Table 3.

TABLE 3
desensitized dispersion viscosities versus pH

| Desen- | | | Desen- | | Approx- |
|---|---|---|---|---|---|
| sitized | Approx- | Approximate | sitized | Approx- | imate |
| dispersion | imate | Viscosity | dispersion | imate | Viscosity |
| Example | pH | (cP) | Example | pH | (cP) |
| A3 | 10.2 | 500 | A4 | 9.1 | 590 |
| A3 | 9.1 | 200 | A4 | 8.0 | 5 |
| A3 | 6.9 | 510 | A4 | 7.2 | 10 |
| A3 | 5.4 | 520 | A4 | 6.3 | 5 |
| A3 | 2.9 | 800 | A4 | 4.0 | 10 |
| A3 | 2.1 | 480 | A4 | 3.7 | 50 |
| A3 | 1.2 | 500 | A4 | 3.0 | 400 |
| N/a* | N/a | N/a | A4 | 2.0 | 10 |
| N/a | N/a | N/a | A4 | 1.5 | 10 |
| N/a | N/a | N/a | A4 | 1.0 | 10 |
| A5 | 9.5 | 600 | A6 | 9.2 | <50 |
| A5 | 9.3 | 100 | A6 | 8.8 | <50 |
| A5 | 8.8 | <50 | A6 | 8.2 | <50 |
| A5 | 8.3 | <50 | A6 | 7.8 | <50 |
| A5 | 7.95 | <50 | A6 | 7.2 | 50 |
| A5 | 7.8 | 5000 | A6 | 6.6 | 1300 |
| A7 | 10.1 | 2600 | A6 | 6.1 | 11,300 |
| A7 | 9.7 | 1900 | A7 | 6.2 | <50 |
| A7 | 9.2 | <50 | A7 | 4.9 | 900 |
| A7 | 8.6 | <50 | A7 | 4.4 | 3500 |
| A7 | 7.9 | <50 | A7 | 3.0 | 4500 |
| A7 | 7.1 | <50 | A8 | 10.7 to 5.0 | <400 |
| A8 | 4.3 | 68,000 | A9 | 9.8 to 8.7 | <200 |
| A9 | 8.1 | 300 | A9 | 7.9 | 400 |
| A9 | 7.6 | 5700 | A9 | 7.2 | 8500 |
| A10 | 9.4 to 6.6 | <200 | A10 | 5.7 | 700 |
| A10 | 4.9 | 4000 | A10 | 2.2 | 7500 |
| A10 | 1.4 | 650 | A10 | 0.7 | <200 |

*N/a means not applicable.

Compare results in Table 3 to the corresponding results of Comparative Example A2.

### Example A11

Repeat Example A4 except use the COABET-desensitized ethylene/1-octene copolymer dispersion of Example 2b (0.25 wt % in COABET) instead of Example 2a (1.0 wt % in COABET); and lower pH only to pH 6.9. Observe that the resulting diluted dispersion is intact at pH 8.6, has a viscosity of 2100 cP at pH 7.3, and a viscosity of 14,000 cP at pH 6.9.

### Example B1

### Extra Metal Cation Tolerance of the COABET-Desensitized Ethylene/1-Octene Copolymer Dispersion

Into a flask add 80 parts by volume of deionized water and 20 parts by volume of the COABET-desensitized ethylene/1-octene copolymer dispersion of Example 2a. Mix the resulting diluted dispersion in vial thoroughly. Slowly add with mixing a 2 wt % calcium chloride solution in deionized water to the diluted dispersion until any phase separation occurs into an upper agglomerates phase and a lower liquid phase. Observe that no agglomeration occurs after adding 0.34 mL of the 2 wt % calcium chloride solution. Favorably compare results in Table 2 to the corresponding result of Comparative Example B1.

As shown by the Examples, the invention dispersion is pH, extra metal cation, or preferably pH and extra metal cation insensitive. The dispersion desensitizer works with any salt of the dispersing carboxylate and with or without using a polar group-containing polymer as an additional dispersion forming agent in the invention dispersions. When pH of the invention dispersion drops below pH 9, when the invention dispersion also contains the non-dispersing additive containing metal cations, or, both, agglomerates formation therein is inhibited.

While the present invention has been described above according to its preferred aspects or embodiments, it can be modified within the spirit and scope of this disclosure. This application is therefore intended to cover any variations, uses, or adaptations of the present invention using the general principles disclosed herein. Further, the application is intended to cover such departures from the present disclosure as come within the known or customary practice in the art to which this present invention pertains and which fall within the limits of the following claims.

What is claimed is:

1. An insensitive aqueous agglomeration-prone thermoplastic polymer dispersion comprising a mixture comprising ingredients (a) to (d): (a) water, as a dispersion medium; (b) agglomeration-prone thermoplastic polymer (APTP) particles, which have a maximum particle size volume mean of 5 microns according to PROCEDURE PSM (described later) and are widely dispersed in the water; (c) a dispersion-forming effective amount of a dispersing carboxylate salt; and (d) an agglomeration-inhibiting effective amount of a dispersion desensitizer; wherein the dispersing carboxylate salt is a cation salt of the anion, R—CO₂⁻, a multi-cation salt of a carboxylic acid polymer comprising carboxyl-containing monomer residuals, or a combination thereof; wherein when the dispersing carboxylate salt is the multi-cation salt of the carboxylic acid polymer, the insensitive aqueous agglomeration-prone thermoplastic polymer dispersion contains at least 1 weight percent of the carboxyl-containing monomer residuals based on ratio of weight of the carboxyl-containing monomer residuals to combined weight of ingredient (b) plus weight of the multi-cation salt of the carboxylic acid polymer; wherein R is an aliphatic radical that is unsubstituted or substituted with from 1 to 6 substituents selected from the group consisting of: —OH, —CO₂H, or a —CO₂⁻ cation salt; wherein each cation (including cations of the multi-cation salt) independently is a cation of a metal of Group 1 or 2 of the Periodic Table of the Elements, ammonium (—NH₄⁺), or a mono-, di-, tri-, or tetra-(C₁-C₆₀)alkyl substituted ammonium; and wherein the APTP particles are exposed to a would-be agglomeration condition and the dispersion desensitizer functions in such a way so as to inhibit agglomeration of the APTP particles in the insensitive aqueous agglomeration-prone thermoplastic polymer dispersion.

2. The dispersion as in claim 1, wherein the would-be agglomeration condition comprises a pH of less than pH 9.0 and the dispersion has the pH of less than pH 9.0; and the dispersion desensitizer functions in such a way so as to inhibit pH-sensitive agglomeration of the agglomeration-prone thermoplastic polymer particles.

3. The dispersion as in claim 1, wherein the would-be agglomeration condition comprises an agglomeration-promotable amount of an extra metal cation, wherein the extra metal cation is derived from an ingredient other than ingredients (b) to (d), and the dispersion contains the agglomeration-promotable amount of the extra metal cation; and the dispersion desensitizer functions in such a way so as to inhibit metal cation content-sensitive agglomeration of the agglomeration-prone thermoplastic polymer particles.

4. The dispersion as in claim 1, wherein the agglomeration-prone thermoplastic polymer particles are polyolefin particles and concentration of the polyolefin particles is from 40 weight percent to 50 weight percent of the dispersion, based on total weight of the dispersion; dispersing carboxylate salt concentration is from 0.5 weight percent to 20 weight percent of the dispersion, based on combined weight of the polyolefin particles plus dispersing carboxylate salt; and dispersion desensitizer concentration is from 0.05 weight percent to 20 weight percent of the dispersion, based on combined weight of the polyolefin particles plus dispersion desensitizer.

5. The dispersion as in claim 1, wherein the mixture of ingredients (a) to (d) is characterized by a viscosity of less than 2,000 centipoise measured according to PROCEDURE VM, and the dispersion consists of, or is prepared from, such mixture.

6. The dispersion as in claim 1, wherein the dispersion desensitizer is a compound of formula (I): 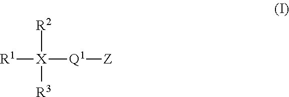
Wherein: X is N cation or P cation; Z is —CO₂ anion, —SO₃ anion, —O—P(O)₂OH anion, —O—P(O)₃ dianion, or —O—S(O)₃ anion; Each of R² and R³ independently is (C₁-C₁₀)alkyl or (C₂-C₁₀)alkenyl; R¹ (C₆-C₃₀)alkyl, (C₆-C₃₀)alkenyl, or R⁴—C(O)N(H)-Q²-; Each of Q¹ and Q² independently is (C₁-C₁₀)alkylene; and R⁴ is (C₆-C₃₀)alkyl.

7. The dispersion as in claim 6, wherein X is N cation; Z is —CO₂ anion; R¹ is (C₆-C₃₀)alkyl; Q¹ is (C₁-C₅)alkylene; and each of R² and R³ independently is (C₁-C₁₀)alkyl; or wherein X is N cation; Z is —CO₂ anion or —SO₃ anion; R¹ is R⁴—C(O)N(H)-Q²-; Q² is (C₂-C₆)alkylene; Q¹ is (C₁-C₅)alkylene; and each of R² and R³ independently is (C₁-C₁₀)alkyl.

8. The dispersion as in claim 1, wherein the dispersing carboxylate salt comprises the cation salt of the anion, R—CO₂⁻.

9. The dispersion as in claim 1, wherein the dispersing carboxylate salt comprises the multi-cation salt of the carboxylic acid polymer containing at least 2 weight percent of carboxyl-containing monomer residuals; wherein the carboxyl-containing monomer residuals of the carboxylic acid polymer independently are derived from the at least one carboxyl-containing monomer.

10.-15. (canceled)
